(19) United States
(12) Patent Application Publication
(10) Pub. No.: US 2026/0323584 A1
(43) Pub. Date: Oct. 15, 2026

(54) INDOOR POSITIONING SYSTEM WITH TEMPORARY ANCHORS

(71) Applicant: Chrome Roads Inc., Vista, CA (US)

(72) Inventor: Frederick Henry Covely, Vista, CA (US)

(73) Assignee: Chrome Roads Inc., Vista, CA (US)

(21) Appl. No.: 19/645,030

(22) Filed: Apr. 10, 2026

Related U.S. Application Data
(60) Provisional application No. 63/787,549, filed on Apr. 11, 2025.

(51) Int. Cl. H04W 64/00; H04L 41/16; H04W 4/33

(52) U.S. Cl. CPC H04W 64/00; H04L 41/16; H04W 4/33

(57) ABSTRACT

An indoor positioning system (IPS) network comprises an interior environment, a plurality of portable locator tags, a plurality of reference anchors, and a deep learning model configured to estimate positions of the portable locator tags. Each tag includes an inertial measurement unit configured to generate inertial data and a transceiver configured to transmit or receive ranging signals. During a training phase, the anchors determine positional coordinates of the tags within the interior environment and provide anchor-derived ground-truth position data together with corresponding inertial data from the tags to the deep learning model. The deep learning model is trained to correlate the inertial data with the ground-truth position data. After training, some or all anchors may be removed or deactivated, and the deep learning model estimates positions of the portable locator tags using inertial data from the tags with reduced or no reliance on the anchors.

### PRIORITY CLAIM

This U.S. nonprovisional application claims the priority of U.S. Provisional Application No. 63/787,549, titled “Cost-Effective Indoor Positioning System with Temporary Anchors,” filed on Apr. 11, 2025.

### BACKGROUND

Positional tracking of persons or mobile objects in buildings by indoor positioning systems (IPS) is faced with challenges of accurately tracking and navigating people or objects in environments where Global Navigation Satellite Systems (GNSS) signals, such as GPS, are unreliable or unavailable. Bluetooth®-based localization employs several well-known techniques for obtaining distances, angles, and coordinates. Received Signal Strength Indicator (RSSI) fingerprinting, for example, involves mapping signal strength at multiple points within a building to create a detailed environmental profile, a receiving device that can measure RSSI can then be located within the map based on the RSSI values it receives from Bluetooth transmitters. While effective, this method can be labor-intensive, requiring frequent updates to account for environmental changes. In addition to Bluetooth, various other radio technologies can be employed for indoor positioning. These technologies often utilize similar core techniques such as phase-based ranging (PBR), round-trip time (RTT), and angle of arrival/departure (AoA/AoD), but operate on different frequencies or employ alternative localization methods. Wi-Fi-based IPS estimates location, using signal measurements from access points (APs). RSSI fingerprinting compares real-time signal measurements to a pre-mapped radio map to estimate location, while other techniques may estimate position using signal strength- or angle-based measurements. Time Difference of Arrival (TDoA) measures arrival time differences across synchronized APs, and Round-Trip Time (RTT), standardized in IEEE 802.11mc, may improve accuracy by measuring signal travel time. Depending on deployment density and infrastructure geometry, Wi-Fi based positioning may increase infrastructure and power costs. Radar IPS determines position and velocity by analyzing radio wave reflections. Common in security and automation, it enables motion tracking even through obstacles. While radar provides high accuracy, its high-power consumption, cost, and interference susceptibility limit scalability for large indoor environments.

In addition to the examples of radio-based approaches, there are several non-radio technologies that also have been implemented, such as cameras, LiDAR, motion capture systems, geomagnetic field-based technologies, particle-filtering approaches, and inertial measurement unit (IMU)-based approaches, such as pedestrian dead reckoning (PDR).

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical examples may only approximate illustrated ideals. For example, smooth surfaces and square intersections can be drawn in disregard of finite roughness, corner-rounding, and imperfect angular intersections characteristic of structures that may be present. Further, where considered appropriate, reference labels have been repeated among figures to indicate corresponding or analogous elements.

FIG. 1 illustrates deployment of an IPS network comprising reference anchors in communication with portable locator tag, in accordance with at least one embodiment.

FIG. 2A illustrates an IPS network comprising two anchors, in communication with a tag, in accordance with at least one embodiment.

FIG. 2B illustrates an IPS network comprising three anchors in communication with a tag, in accordance with at least one embodiment.

FIG. 3 illustrates a schematic diagram of an IPS network, in accordance with at least one embodiment.

FIGS. 4A-B illustrate an IPS network, in accordance with at least some embodiments.

FIG. 4C illustrates a block diagram of an electronic circuit onboard tag, in accordance with at least one embodiment.

FIG. 4D illustrates a block diagram of an electronic circuit onboard anchor, in accordance with at least one embodiment.

FIG. 5A illustrates a flowchart summarizing a method for operation of an IPS network in a training phase, in accordance with at least one embodiment.

FIG. 5B illustrates a flowchart summarizing an example of a training phase system, in accordance with at least one embodiment.

FIG. 6A illustrates a flowchart summarizing a method for operation of an IPS network in a post-training phase of operation (e.g., routine operation), in accordance with at least one embodiment.

FIG. 6B illustrates a flowchart summarizing an example of a post-training phase system, in accordance with at least one embodiment.

FIG. 7 illustrates a processor system with a machine-readable storage medium having machine-readable instructions that when executed cause a microcontroller in a circuit board of a control unit for tag, anchor, and/or servers, to execute the machine-readable instructions according to the methods of FIGS. 5A and 6A, in accordance with at least one embodiment.

### DETAILED DESCRIPTION

Despite the diversity of indoor localization approaches, existing systems may face tradeoffs between accuracy, scalability, infrastructure requirements, and cost. Many require extensive infrastructure or rely on labor-intensive training and mapping phases. Some applications demand centimeter-level accuracy, while others may only require accuracy within 10 meters or more. In most indoor positioning systems (IPS), the training period is typically separate from actual user operation, often relying on specialized equipment like motion capture systems to gather training data. Once trained, the system shifts to user-facing devices, creating a divide between training and deployment. In some cases, the equipment used during training may interfere with the natural movement or posture of the trainers themselves (e.g., chest harnesses, handheld measuring equipment, 2D or 3D goggles).

Described herein is an indoor positioning system (IPS) having temporary anchors, where anchors are position-detection sensors deployed within an interior environment. In at least one embodiment, anchors can be of a temporary nature, in that they may be removed or reduced in number once a training phase is completed. The disclosed IPS combines Bluetooth-based high accuracy IPS technologies in anchors and tags, inertial measurement units (IMUs) within the tags, and a deep learning model which may be cloud-based or included on the tag itself, to deliver a positioning solution for indoor localization. A deep learning model is trained using IMU-based motion data and Bluetooth-derived ground truth location data to generate a machine-learned positioning model capable of estimating device location post-training with reduced or no reliance on external radio beacons.

In a post-training phase, the disclosed IPS may not require more than motion information derived from IMU data, such as heading and velocity, estimated from inertial measurement data acquired from mobile personnel or objects. Such information may be collected as raw data by IMUs, such as microelectromechanical systems (MEMS)-based accelerometers or gyroscopes incorporated into tags worn by persons or other mobile objects moving about within the interior environment. IMU and other data may be periodically transmitted to anchors disposed about the interior environment. Thus, in at least one embodiment, some or all anchors may be temporarily employed during the training phase of operation. The removal of some or all anchors during the post-training phase of operation can yield significant cost savings in terms of power and equipment usage. During a post-training or routine operation of the IPS network, IMU data from tags may be sufficient to generate estimates of tag positions without direct ground truth knowledge of the tag positions. In at least one embodiment, deactivated anchors may be reemployed (e.g., reactivated) for periodic verification of the accuracy of tag location estimates, and for occasional or periodic recalibration of the IPS network. Such data may also be gathered by anchors through a query protocol, for example, where the anchor pings the tag to obtain IMU data stored within a memory device on the tag. The deep learning model of the disclosed IPS may then analyze the raw data and subsequently can map movement patterns within the interior environment. The deep learning model of the disclosed IPS is well-suited for dynamic environments such as interior environments intended for implementation of the disclosed IPS.

Examples of an interior environment may be a hospital, a shopping mall, a school, a library, an office building, to name a few. Anchors in the form of sensors and receivers of various types may be deployed at strategic locations within the interior environment. In some embodiments, anchors may detect the presence of tagged persons or mobile objects, count such persons or objects, and/or associate detections with individual tags. For example, anchors may be deployed at entrances and exits between rooms or portions of a building, and at staircase or escalator landings where tagged personnel moving horizontally or vertically, such as among different floors of a building, may be detected and counted. During a training phase, Bluetooth B-HAP(Bluetooth High Accuracy Positioning) radios (e.g., transceivers) associated with anchors and/or tags may employ ranging and/or directional techniques, such as phase-based ranging (PBR), round-trip time (RTT), angle of arrival (AoA), and/or angle of departure (AoD), to determine reference-position data for tagged personnel or mobile objects. IMU data acquired from the same tags, such as accelerometer data indicative of motion and barometric data indicative of change in height, may be temporally associated with the reference-position data and used to train the deep learning model. In a post-training phase, the disclosed IPS may determine position based on inertial measurement data obtained from hardware, such as MEMS accelerometers and gyroscopes, on board tags carried by personnel or other mobile objects, with reduced or no reliance on anchors. In some embodiments, one or more anchors may remain deployed to assist in location determination. Thus, the deep learning model may be contained locally within the interior environment or on a cloud-based server.

Examples of B-HAP position and directional measurement techniques within the disclosed IPS include Phase-Based Ranging (PBR), Round Trip Time (RTT), Angle of Arrival (AoA) and Angle of Departure (AoD) methods. In some embodiments, Bluetooth Low Energy transceivers are incorporated into tags and anchors included in the disclosed IPS. While the B-HAP technologies are discussed, they are primarily used as examples. Thus, in some embodiments, other RF telemetry platforms and protocols besides Bluetooth may be employed. For example, such technologies and protocols can include Wi-Fi based systems to transmit and receive positional telemetry via Wi-Fi routers and other Wi-Fi based transceivers. Wi-Fi-based IPS may estimate location of personnel or objects using signal measurements from access points (APs) as anchors. In addition to the techniques enumerated above, both Wi-Fi- and Bluetooth-based systems may utilize RSSI (Received Signal Strength Indicator) fingerprinting, in which signal measurements are compared with a pre-mapped radio map to estimate location. . For example, signal measurements collected at know reference locations within a building may be mapped to obtain a radio fingerprint of the interior environment. The techniques enumerated above are defined below.

Ultra-wideband (UWB) technology is another radio (RF) protocol that differs from Bluetooth and Wi-Fi in that it may offer higher positional accuracy. UWB is a short-range, high-bandwidth protocol that uses low-power, high-frequency radio pulses for precise real-time spatial sensing and data transmission. Enabling UWB may offer high positional accuracy, such as on the order of a centimeter or better. The basic RF technology enabling UWB is like radar-based pulse technology, but having a higher bandwidth, for example approximately 500 MHz or greater. In addition, most radar hardware consumes significant power to generate high-level pulses. The positioning techniques may be supported by UWB, such as phase difference of arrival (PDoA), time difference of arrival (TDoA), time-of flight (ToF), and two-way ranging (TWR).

Radar-based IPS can determine positions and velocities and directions of mobile objects, including persons traversing an interior environment. However, radar-based anchors may consume significant power, thus can be more expensive than UWB to deploy and operate. Radar is also susceptible to interference.

Turning to the deep learning model, training relies on ground truth location data. Ground truth location data may refer to the location of a tag as derived from measurements involving anchors at known fixed positions. For example, known fixed-positional information for anchors may be obtained through direct observation or measurement. Anchors may be deployed at positions mapped by coordinates chosen relative to a fixed origin or reference position. During a training phase, the system may determine location of the tag using the anchors and Bluetooth-based positioning capabilities of the disclosed IPS, while the deep learning model is trained using the resulting ground truth location data together with corresponding IMU data from the tag. Accordingly, the system may provide location information during the training phase while also generating training data for the deep learning model. In at least one embodiment, most or all of the local anchors utilized during the training phase are removed or deactivated after training. At the conclusion of the training phase, the deep learning model may be sufficiently trained to estimate positions and predict movements of mobile objects, including personnel, with reduced or no reliance on the spatially arranged anchors employed during the training phase, based on IMU data obtained from the tag. In some embodiments, one or more anchors may remain deployed to calibrate, verify, and/or augment the deep learning model after training.

During the training phase, output from multiple anchors and/or tags deployed within the three-dimensional space of the interior environment may be transferred to the deep learning model over an internet link. In at least one embodiment, anchors and/or tags may transmit tag-anchor measurement data to a deep learning model via a Bluetooth or Wi-Fi gateway. The measurement data may be accompanied by IMU data obtained by inertial hardware on board the tag. Distance and/or angular measurements between a tag and one or more anchors may be obtained using Bluetooth high-accuracy positioning methods, such as angle of arrival (AoA), angle of departure (AoD), round-trip time (RTT), and/or phase-based ranging (PBR), implemented in software stored and processed on board the tag, one or more anchors, a gateway, and/or a cloud- or locally based server. Using the resulting distance and/or angular measurements, the position of the tag may be determined by trilateration, multilateration, angulation, and/or other position-determining computation, depending on the measurement type and deployment geometry. Once sufficient measurements are available, the position of the tag may be determined in two or three dimensions, depending on anchor geometry and any available height information. The resulting position data may be generated on board the tag, the one or more anchors, the gateway, and/or the cloud- or locally based server, and may be provided to the deep learning model together with corresponding IMU data from the tag. In this manner, data provided by the tags and anchors may serve two purposes: first, to accurately report the position of the tag or tag bearer during the training phase; and second, to provide ground truth for training the deep learning model against corresponding IMU data from the tag. Once trained, the deep learning model may estimate location information using IMU data from the tag with reduced or no reliance on the anchors, and in some embodiments the anchors may be partially or completely removed.

In at least one embodiment, hardware used during the training phase may also be as that used during the post-training operation of the disclosed IPS. As noted above, the deep learning model incorporates a neural network trained on multimodal datasets to enhance localization accuracy. The deep learning model may incorporate a neural network trained using ground truth location data derived during the training phase together with corresponding IMU-derived motion data, such that, in the post-training operational phase, the trained neural network may estimate position using IMU-derived motion data without requiring the ground truth location data used for training.

In at least one embodiment, some or all anchors may be removed from the interior environment, allowing the deep learning model to interact directly with any position/motion-measuring hardware on board the tags. For example, the deep learning model may obtain IMU data directly from the tags. The deep learning model may be present in part or entirely on the tags’ computational processing hardware, if so equipped, which may include one or more processors and memory. As noted above, in some embodiments, tags may also or alternatively communicate with a cloud server running the deep learning model software via a Bluetooth- or Wi-Fi-enabled gateway. Besides Bluetooth and Wi-Fi, other wireless telemetry protocols such as LoRa, ANT/ANT+, Zigbee, 6LoWPAN, Wireless USB, Thread Mesh Networking, and other short-range wireless networking platforms may be used as well to provide local and cloud connectivity. A transition from training phase to a post-training phase of operation of the IPS may be imperceptible to human personnel carrying the tags.

In some embodiments, the deep learning model may be contained as software stored in a local central computer, where the computer is on site within or close to the interior environment. In other embodiments, the deep learning model may be contained within memory on board the tags. In such a configuration, the data obtained by an IMU or other positional sensor that is also on board the tag may be directly transferred to the deep learning model. The local copy of the deep learning model may be in communication with a local or cloud-based server, where data may be archived, sorted, and further analyzed.

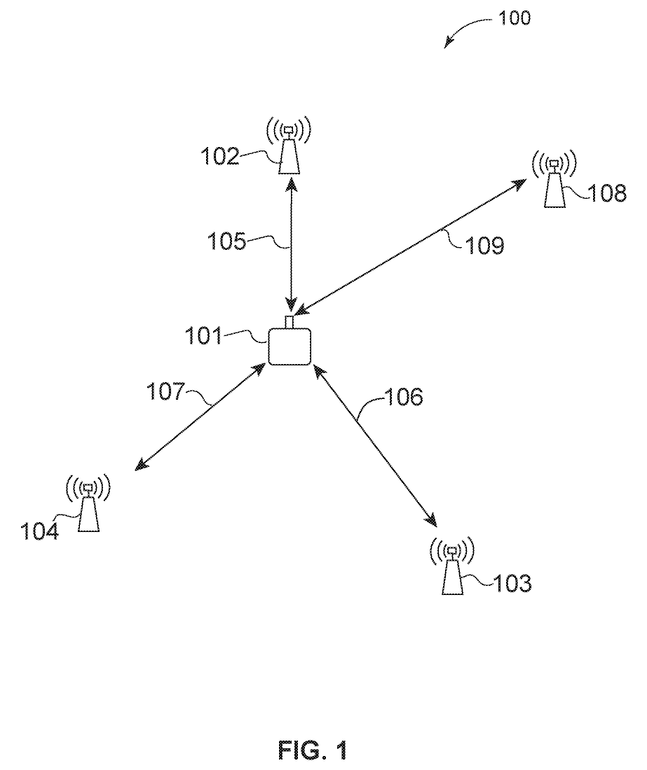

FIG. 1 illustrates deployment of an IPS network 100 comprising reference anchors 102, 103, 104 and 108 (henceforth, anchors 102, 103, 104 and 108) in communication with portable locator tag 101 (henceforth, tag 101). In at least one embodiment, tag 101 may transmit a ranging signal beacon that is received by the anchors. The four anchors in FIG. 1 may work together to determine the position of tag 101. In some embodiments, IPS network 100 may employ B-HAP technologies, which may include a combination of phase-based ranging measurements (PBR) and round-trip timing (RTT) in some embodiments to precisely calculate the distances between the tag and anchors 102, 103, 104. Phase-based ranging (PBR) measures distances by analyzing phase differences in signals exchanged between devices across multiple frequencies. Round trip time (RTT) calculates distances based on the time a signal takes to travel between a transmitter and a receiver. In yet other embodiments, both PBR and RTT are combined to enhance accuracy.

It is understood that anchors 102, 103 and 104 reside on the same plane (e.g., floor, level). Because the locations of the anchors are fixed (e.g., x and y coordinates of each anchor are stored in a memory accessible to local or cloud-based processor running the deep learning model or software peripheral to the deep learning model), the calculated distances from each anchor to tag 101 allow the use of trilateration to determine positional coordinates (e.g., x and y) of tag 101. For example, distance 105 between anchor 102 and tag 101, distance 106 between anchor 103 and tag 101, and distance 107 between anchor 104 and tag 101 provide the distances between tag 101 and positions of anchors 102, 103 and 104, enabling trilateration to find an instantaneous position (e.g., x and y coordinates) of tag 101.

In at least one embodiment, tag 101 communicates with four anchors to determine a three-dimensional (e.g., x, y, z) location of tag 101. While four anchors are shown in the illustrative example, tag 101 may communicate with any suitable number of anchors to increase accuracy of positioning. In some embodiments, three anchors may be sufficient for effective location of any one tag within IPS network 100. While three anchors (e.g., anchors 102, 103, and 104) enable accurate location of a tag in a planar coordinate system (e.g., x and y), a fourth anchor (e.g., anchor 108) positioned out of plane, that is, at a height above the plane or level where the three co-planar anchors (anchors 102, 103 and 104) reside, may enable z-position determination by multilateration, where the four distances, including distance 109 between anchor 108 and tag 101, are input to, for example, the deep learning model to solve for the x, y and z coordinates of tag 101. In some embodiments, the system may include peripheral software, which may calculate the position of tag 101.

In addition to using multilateration with four or more anchors, IPS network 100 can also determine the altitude (e.g., z coordinate) of tag 101 using a barometer integrated within tag 101. In some embodiments, a processor may be included within an internal circuitry of tag 101. An onboard processor can convert the pressure reading from a barometer into an altitude using known atmospheric models or calibration data. This altitude measurement can be used independently or in conjunction with the anchor-based trilateration or multilateration to provide a more robust and accurate 3D location.

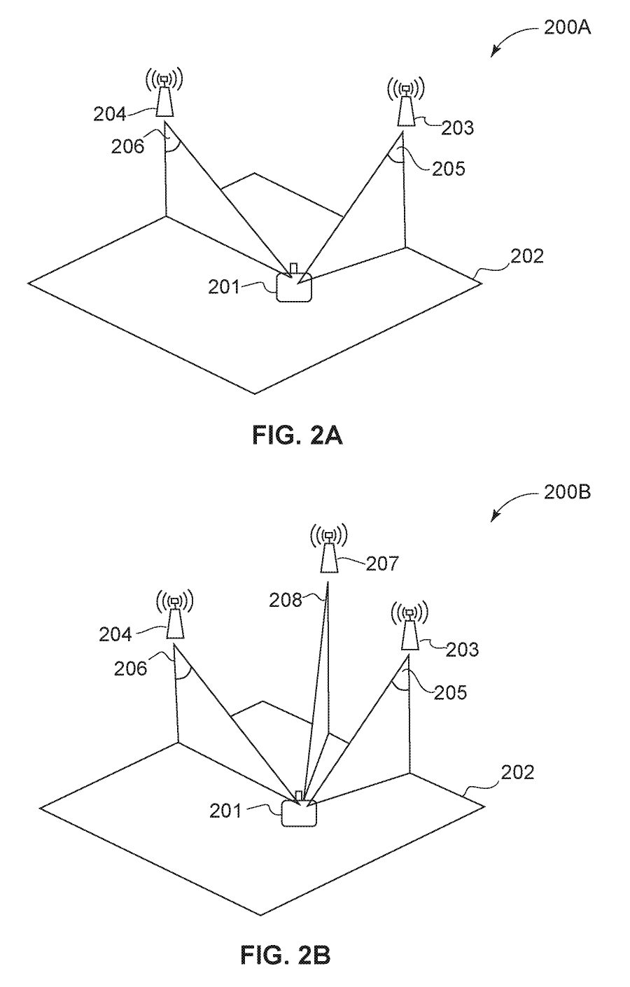

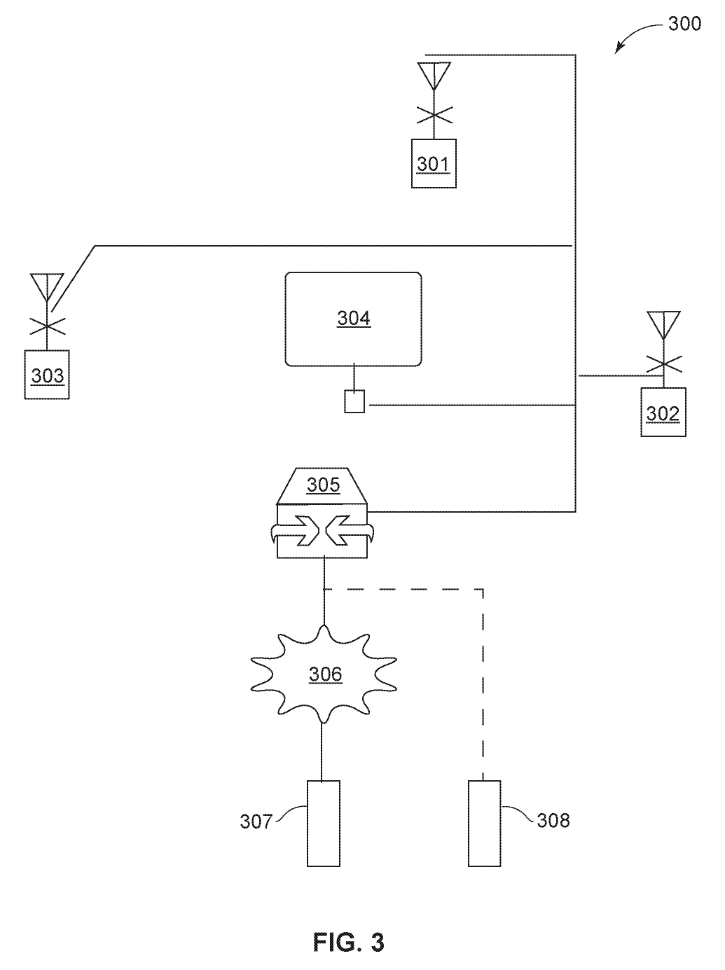

FIG. 2A illustrates an IPS network 200A comprising two anchors 203 and 204 in communication with a tag 201, in accordance with at least one embodiment. In the illustrative embodiment, IPS network 200A is a two-dimensional system, meaning that coordinates of tag 201 and anchors 203 and 204 are substantially defined as x, y coordinates on plane 202. IPS network 200A may employ angle-based positioning techniques, such as Angle of Arrival (AoA) and/or Angle of Departure (AoD), to determine a direction or bearing of tag 201 relative to anchors 203 and 204. AoA and/or AoD may enable measurement of angular information associated with signals exchanged between tag 201 and one or more anchors, such as anchors 203 and 204. To enable angulation, anchors 203 and 204 may have multiple antennas arranged in phased arrays to estimate the angular measurements 205 and 206 by determining the direction of the strongest signal level with respect to the orientation of the phased antenna array. Two or more so-equipped anchors may pinpoint the location of tag 201 by angulation. The angular data may be used to determine x and y coordinates of tag 201 on plane 202.

FIG. 2B illustrates an IPS network 200B comprising three anchors 203, 204, and 207, in communication with tag 201, in accordance with at least one embodiment. Anchors 203, 204 and 207 may process signals exchanged with tag 201 using AoA and/or AoD techniques to resolve instantaneous x, y, and z coordinates of tag 201. The AoA and/or AoD measurements may employ antenna-array-based angular estimation to determine angle information, such as angular measurements 205, 206 and added angle 208 The measurements may be repeated at intervals of several tens of milliseconds to seconds to develop a movement pattern of tag 201. While three anchors are depicted in FIG. 2B, three-dimensional coordinates may be determined by two anchors, as shown in FIG. 2A, using a barometer or other means to determine altitude (z position) of tag 201.

In still other embodiments, IPS networks 200A and 200B may be configured to employ one or more of these technologies individually or in combination to optimize accuracy based on environmental conditions and use case requirements. By integrating distance and/or angular measurements from multiple anchors, IPS networks 200A or 200B may determine the position of tag 201. In some embodiments, tag 201 may be a wearable device, smart card, or asset tracker capable of being located and tracked in a three-dimensional space (x, y, and z coordinates). The location data obtained through these techniques may serve as ground truth data for training a deep learning model which, once trained, may estimate the position of tag 201 based on inertial measurement unit (IMU) data with reduced or no reliance on fixed anchors in post-training operation.

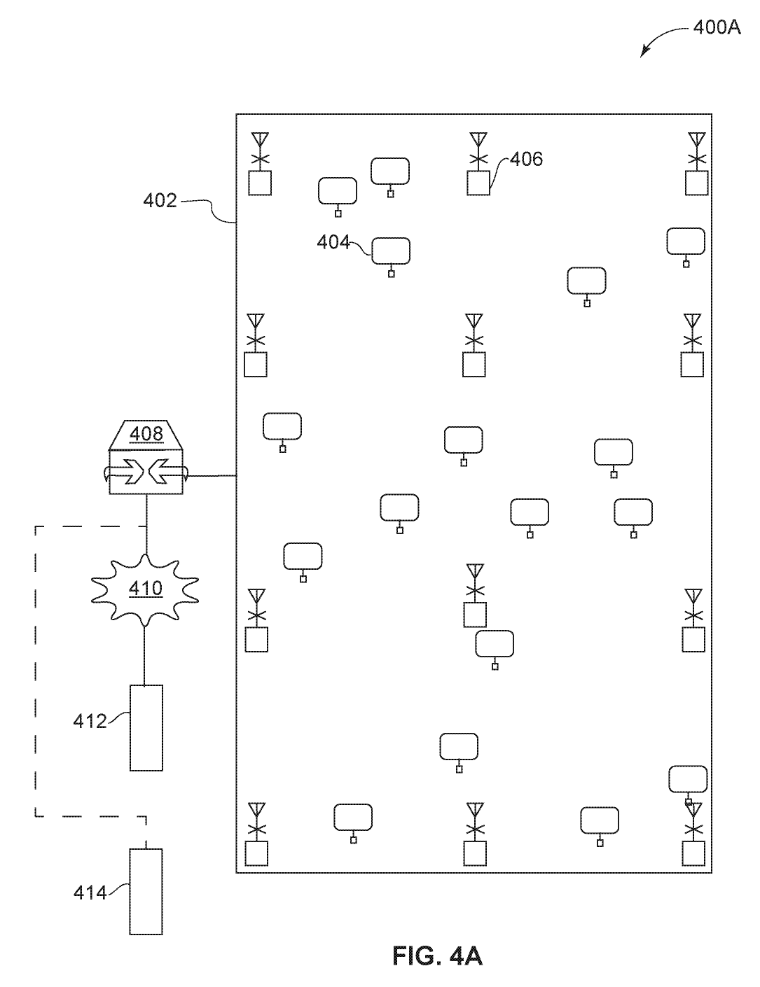

FIG. 3 illustrates a schematic diagram of an IPS network 300, similar to IPS networks 100, 200A, and 200B, in accordance with at least one embodiment. IPS network 300 comprises anchors 301, 302, and 303, and tag 304. While three anchors are depicted, any suitable number of anchors may be included in network 300. In some embodiments, three anchors may be sufficient to determine location of tag 304, depending on deployment geometry and available height information. Anchors 301, 302, and 303 may process signals exchanged with tag 304 in a manner similar to that described above for IPS networks 200A and 200B. For example, in some embodiments, AoA and/or AoD techniques may be employed to determine coordinates of tag 304. In other embodiments, PBR and/or RTT techniques may be employed to calculate coordinates of tag 304 by trilateration, multilateration, and/or other position-determining computation. While two or three anchors may be sufficient to obtain a location of tag 304, any suitable number of anchors may be included in network 300.

In at least one embodiment, data from any anchors 301, 302, and 303, and/or tag 304, may be transmitted to a cloud-based server 307 running the deep learning model via a gateway 305. For example, IPS network 300 may employ Wi-Fi, Ethernet, Bluetooth or other wireless RF protocols such as those mentioned above, to provide connectivity with cloud 306. In other embodiments, gateway 305 may communicate with a local server 308 via wireless technology or by Ethernet. While anchors 301-303 may transmit position-related data for tag 304 to the deep learning model, tag 304 may transmit IMU data to servers 307 or 308 running the deep learning model via gateway 305. In some embodiments, gateway 305 may run administrative service routines to manage data transfer. In other embodiments, server 307 or server 308 may run administrative service software. While server 307 and/or 308 may comprise a processor capable of performing calculations for the deep learning model, in some embodiments, tag 304 may also host a processor that can perform computations for the deep learning model. In at least one embodiment, the deep learning model may reside on tag 304. In other embodiments, the deep learning model may reside on cloud-based server 307 and/or local server 308 in lieu of or in addition to tag 304.

In some embodiments, IPS network 300 may be configured so that some or all anchors 301-303 may comprise devices to enable the anchors to function as gateways, eliminating a stand-alone gateway device. Thus, gateway 305 may be integrated into anchors 301-303 and/or tag 304. In at least one embodiment, some or all the deep learning model may be stored on tag 304, enabling reduction or elimination of continuous reliance on gateway connectivity in a post-training phase of operation of IPS network 300. Such a configuration may enable simplification and cost reduction of IPS network 300.

In at least one embodiment, anchors 301-303 may be temporarily deployed during a training phase, where the deep learning model obtains location data of tag 304 (which may represent a plurality of tags) and develops patterns of movement. In a post-training phase of operation of IPS network 300, anchors 301-303 may be partially or entirely removed. In some embodiments, some or all of anchors 301-303 may remain in the post-training phase, but in a dormant state. At any time during the post-training phase, some or all remaining anchors may be re-activated selectively to verify the performance and accuracy of IPS network 300. Remaining anchors may be located at fixed coordinates in a permanent or quasi-permanent manner. Such anchors may be placed strategically about the interior environment.

The deep learning model may include a variety of neural network architectures. For example, the deep learning model may include one or more convolutional neural networks (CNNs), which may be employed for feature extraction from spatial data, such as RSSI heat maps, Bluetooth signal fingerprints, and/or windowed inertial measurement data. In other embodiments, the deep learning model may comprise recurrent neural networks (RNNs), Long Short-Term Memory (LSTM) networks, and/or gated recurrent unit (GRU) networks. Such networks may be employed to process sequential data, such as IMU signals and RSSI time series, to model motion and trajectories over time.

In some embodiments, the deep learning model may comprise transformer-based and/or attention-based architectures configured to model temporal dependencies in IMU data and/or signal data over extended intervals. In some embodiments, the deep learning model may employ multi-stage architectures in which a first stage estimates one or more motion-related quantities, such as displacement, heading, or velocity, and a second stage estimates location based at least in part on the one or more motion-related quantities. In further embodiments, the deep learning model may comprise learned inertial odometry architectures that are coupled with one or more state-estimation algorithms, such as Kalman filters, extended Kalman filters, and/or related filtering techniques.

In some embodiments, the deep learning model or peripheral software may include autoencoders, including denoising autoencoders, which may be employed for dimensionality reduction, feature compression, and/or noise removal in inertial and/or signal data. In other embodiments, the deep learning model may employ Siamese networks for similarity-based learning, such as comparing signal fingerprints, inertial patterns, and/or multimodal feature representations associated with different locations. In still other embodiments, Generative Adversarial Networks (GANs) or other generative models may be employed for data augmentation, denoising, and/or generation of synthetic training data. In some embodiments, training data may also be augmented using simulated inertial noise, perturbed trajectories, and/or other synthetic data augmentation techniques to improve robustness of the deep learning model.

In at least one embodiment, hybrid models may be employed to combine spatial feature extraction, temporal modeling, and/or sensor-fusion processing for location estimation. Such hybrid models may include CNN-LSTM, CNN-GRU, CNN-DNN, transformer-based hybrid architectures, and/or architectures configured to fuse IMU data with Bluetooth-, Wi-Fi-, ultra-wideband-, and/or other anchor-derived measurements. In at least one embodiment, the deep learning model may be trained using anchor-derived ground truth location data together with corresponding IMU data and may, after training, estimate position based on IMU data alone or based on IMU data in combination with measurements from one or more remaining anchors. In some embodiments, portions of the deep learning model may execute on a tag, anchor, gateway, local server, cloud server, or combinations thereof, depending on processing capability, power consumption, communication bandwidth, and/or latency constraints.

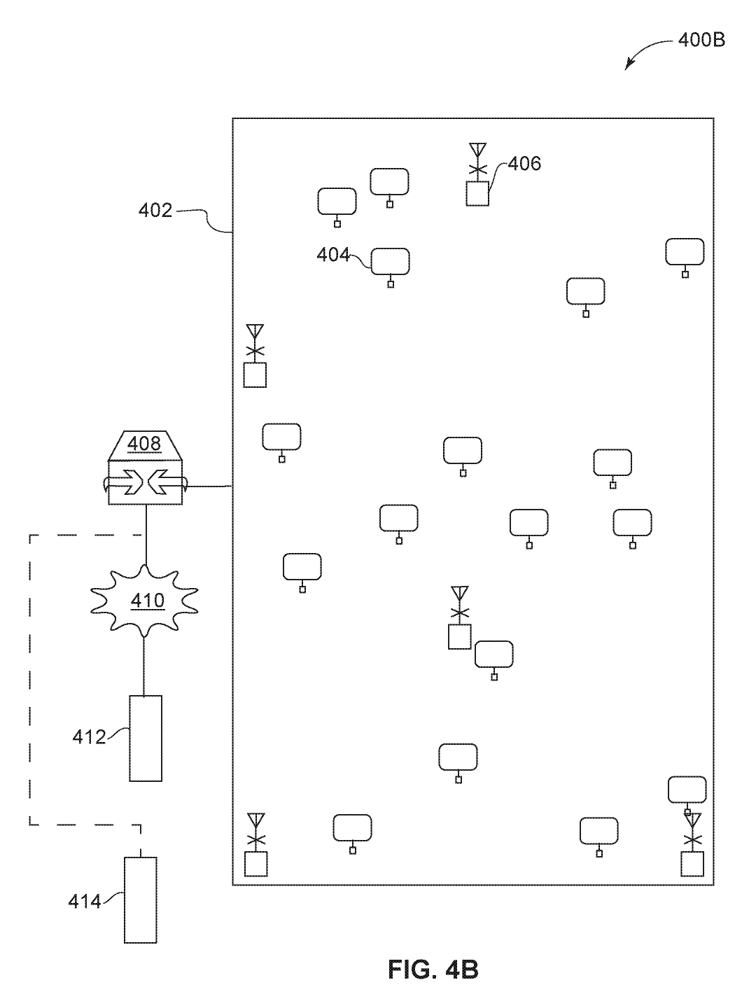

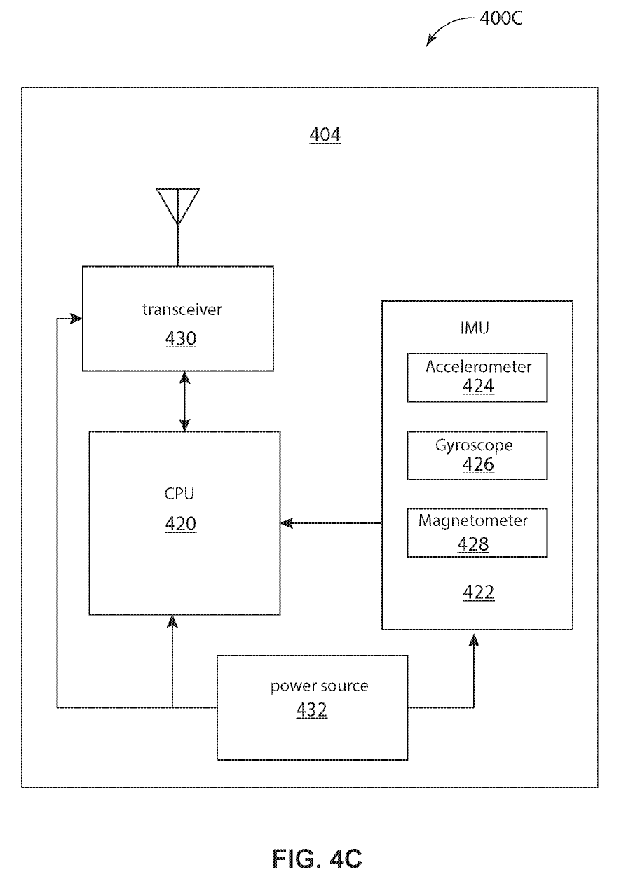

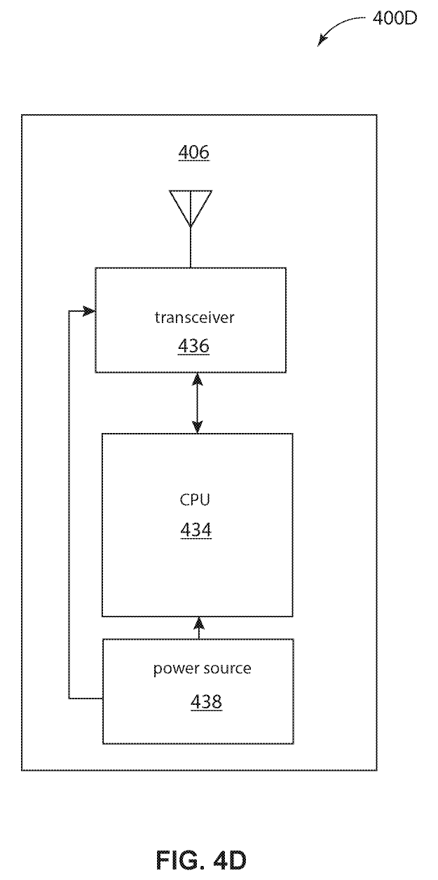

FIG. 4A illustrates an IPS network 400A, comprising an interior environment 402, in accordance with at least one embodiment. In at least one embodiment, interior environment 402 may include, but not be limited to, a building or group of buildings housing a factory, a warehouse,, an office building, a shopping mall complex, a school, buildings on a college campus, a hospital, a hotel, an apartment or condominium building, a train station, an airport, a sport center, or a vacation resort. Interior environment 402 may be a single level (e.g., one story) building, or maybe a building having multiple levels. For example, interior environment may be a skyscraper office building in a large city, having more than twenty floors. As an example, IPS network 400A may track the ensemble of personnel moving within the office building, mapping locations of tags worn or carried by employees and visitors. As an example of utility, sub-hourly, hourly or daily movement maps may be constructed by the deep learning model to identify places where personnel may congregate or pass through on an hourly or daily average. Movements of individuals may be tracked as well.

Interior environment 402 may also be housed within a temporary structure, such as a large pavilion tent erected at, for example, a large fair or expo. Interior environment 402 may also be an underground transportation station, such as a subway station or network of subway stations in a large city. Another example is an underground shopping mall in a city where inclement weather is frequent or sub-zero temperatures may persist for a significant portion of the year, enabling shoppers to move about the underground interior environment in relative comfort. In some embodiments, interior environment 402 may be a building that houses animals, where the animals wear tags 404.

Distributed within interior environment 402 is a plurality of tags 404 and anchors 406. Tags 404 may be portable devices as described above and are generally mobile, for example worn or carried by personnel. Tags 404 may also, in some embodiments, comprise identification devices such as RFID cards or other interrogatable tags attached to inanimate but mobile objects for tracking purposes. For example, such mobile objects may be goods undergoing manufacture along one or more assembly lines in a factory. Individual objects or lots of objects may be tagged and tracked by IPS network 400A for keeping track of inventory or following the progress of a lot of manufactured goods moving through a factory from one area to another. Similarly, for a warehouse, inventory may be tagged and tracked by means of IPS network 400A.

In at least one embodiment, tags 404 may comprise an on-board electronic circuitry. One or more processors (e.g., CPUs) and associated memory may be included within the electronic circuitry. A plurality of sensors may be included in the electronic circuitry of tags 404. These sensors may include one or more sensors configured to measure or sense temperature, barometric pressure, moisture, light colors and levels, ionizing radiation, acceleration, orientation relative to earth’s magnetic field, acoustic signals and power levels, and chemical particulates, vapors or gases. The plurality of sensors may be coupled to on-board processors.

The electronic circuitry on-board tags 404 may include wireless digital transceivers such as Wi-Fi or Bluetooth transceivers. Such transceivers may be configured to transmit and receive telemetry data, as well as being configured to interact with on-board processors. For example, wireless transceivers may transmit IMU data derived from on-board inertial sensors (e.g., accelerometers, gyroscopes) to anchors 406. Tags 404 may include one or more batteries to power the electronic components and sensors included within the electronic circuitry. Such batteries may comprise a rechargeable lithium-ion chemistry, for example.

The processors on board tags 404 may direct on-board wireless transceivers to emit signals to be intercepted by individual anchors or by an array or cluster of anchors, such as those shown in FIGS. 1-2B. The array of anchors may include three or four anchors configured to intercept and process signals exchanged with tags 404, where angle-of-arrival and/or other signal characteristics may be analyzed. Transceivers on board tags 404 may be configured to transmit pulsed or continuous signals to be received by arrays or clusters of anchors 406. For example, phased antenna arrays onboard at least three anchors 406, for example, within receiving distance of an individual tag, may enable dynamic determination of tag location using AoA and/or AoD techniques as described above. Trilateration or multilateration may also be performed using PBR and/or RTT techniques, and/or location may be estimated using RSSI fingerprinting, to dynamically determine the position of the individual tag 404. By combining these distance or angular measurements from multiple anchors, position of the individual tag may be determined in two-dimensional or three-dimensional space. The dynamically determined location data may serve as ground truth data for training the deep learning model.

Tags 404 may also transmit IMU telemetry data derived from on-board accelerometers and/or gyroscopes to anchors 406. Magnetometer data may also be employed to indicate orientation of the tag with respect to earth’s magnetic field. For example, a Hall effect electronic compass may be incorporated on board tags 404. The IMU-derived data may be used to estimate motion-related information for the tag, such as speed, acceleration, deceleration, heading, and/or direction of movement. In some embodiments, IMU data may be used in lieu of B-HAP signals to characterize motion of tags 404. As will be described below, IMU data may be relied upon during a post-training phase of operation of IPS network 400A, or IPS network 400B described below with reference to FIG. 4B, to estimate location information with reduced or no reliance on anchors.

In some embodiments, metadata telemetry from other sensors that may be included in a sensor suite on-board tags 404 may be transmitted from tags 404 to anchors 406. For example, barometric data for tag z-height determination may be transmitted as telemetry data to anchors 406. Other telemetric data may also be transmitted by tags 404, such as temperature, light level, moisture or chemical environment data.

In at least one embodiment, processors on board tags 404 may be configured to run software that partially or entirely comprises the deep learning model. In some embodiments, processors on board tags 404 may be configured to run peripheral software, for example, software that is not part of the deep learning model but may perform repetitive computations in parallel to computations performed by the deep learning model, transferring data continuously or intermittently to the deep learning model. Peripheral software may also manage hardware such as sensors and wireless transceivers, for example, providing a soft interface to the deep learning model. In some embodiments, peripheral software, if included, may be run on separate processors or on one or more cores of a single processor.

Similarly, anchors 406 may comprise on-board electronic circuitry that includes wireless transceivers coupled to on-board processors and memory. Anchors 406 may function as individual nodes within IPS network 400A. Further included within electronic circuitry onboard anchors 406 may be a Wi-Fi or a Bluetooth router or access point (also similar routers or gateways for other wireless technologies) for LAN (local area networks, including wireless LANs), and/or VLAN (virtual local area network) client management. For example, local server 414 may be connected via a WLAN to anchors 406 and/or tags 404. Anchors 406 may also provide ports for ethernet connectivity to external gateways, such as gateway 408 in FIG. 4A. Depending on the level of functionality, anchors 406 may be simple or sophisticated network devices. An example of the latter functionality is anchors having, in addition to a CPU and wireless transceiver, internal gateways that may communicate wirelessly or by Ethernet with a central router connected to the internet.

Internet connectivity may enable access to cloud-based network components, such as cloud server 412. In at least one embodiment, cloud 410 may represent the internet, however in other embodiments, cloud 410 may represent a LAN. In some embodiments, IPS network 400A may optionally or exclusively include a local server 414 connected to anchors 406 via a LAN. A LAN may offer greater security in some implementations of IPS network 400A. Cloud server 412 or local server 414 may be configured to run software that constitutes part or all the deep learning model. For example, in some embodiments, the deep learning model may be contained on servers 412 and/or 414. In other embodiments, algorithms of the deep learning model may be distributed on tag- and/or anchor-borne computing systems.

In some embodiments, positional and inertial data from anchors and/or tags may be transferred via cloud (e.g., internet) 410 to cloud server 412, enabling the deep learning model to be centralized on servers. The servers may process the location and directional data to derive position data for tags within interior environment 402. In other embodiments, tag- and/or anchor-borne deep learning model algorithms may perform calculations of tag position data.

In at least one embodiment, IPS network 400A is configured to provide training data to the deep learning model. Referring to interior environment 402, multiple anchors 406 may be distributed at selected locations within interior environment 402. Anchors 406 may be located at fixed positions, with positional coordinates (e.g., x, y, and z) known and stored in memory locations accessible to the deep learning model.

For example, anchor coordinates may be stored in memory locations on cloud server 412 or local server 414. In at least one embodiment, most or all of anchors 406 are not permanently affixed to their positions. In some embodiments, anchors may be spaced apart from one another by 10 to 30 meters. Spacing between anchors may depend on the particularities of interior environment 402 and level of desired accuracy of tag location. Designated anchors may be removed once training of the deep learning model is completed. Completion of the training phase may be determined when the deep learning model can reliably estimate position of tags within interior environment 402 based on IMU data, with reduced or no reliance on the anchors.

In other embodiments, some or all anchors 406 may be left in place but deactivated in a post-training phase of operation (see below). Some or all the deactivated anchors 406 may be re-activated periodically during the post-training phase for verification and/or recalibration of position estimates generated using IMU data transmitted by tags 404.

Tags 404 may be generally mobile. As previously noted, tags 404 may be carried by personnel ambulating within interior environment 402, or by mobile inanimate objects being transferred from one location to another within interior environment 402. As positions of tags 404 change, tags may be configured to continually update transmitted data. In some embodiments, tags 404 transmitting barometer telemetry data may use fewer anchors to locate such tags within interior environment 402.

For example, two or three anchors rather than three or four anchors may effectively locate three-dimensional coordinates (x, y, and z coordinates) of a tag, where the barometric data serve to provide z-height (altitude) information of the tag. In other embodiments, z-height information of a tag may employ RFID terminals or permanent anchors at the entrances to floors within a multilevel building, for example, or at other locations within the floor, providing z-height information.

During the training phase, tags 404 are deployed within interior environment 402 and continuously transmit signals (e.g., ranging signals) enabling distance and/or angulation calculations by anchors 406. Tags 404 may also send IMU data to the deep learning model as they traverse the area. The data being forwarded to the deep learning model provides location coordinates (ground truth), while the IMU data forwarded from tags 404 may capture motion and orientation data. A combined dataset comprising positional and IMU data may be used to train the deep learning model, as described below.

In a post-training phase, the deep learning model may use IMU data from tags 404 and rely on these data in the absence of positional information afforded by B-HAP (and other) position-determining techniques to dynamically determine location information for the ensemble of tags 404. In at least one embodiment, to exclusively enable reliance on IMU data to obtain position estimate data for the ensemble of tags 404, the model is trained with training data sets combining positional data synchronized with corresponding IMU data. In this manner, the deep learning model receives paired datasets comprising IMU data and a ground truth location coordinate. The deep learning model may learn to associate IMU readings with tag positions within interior environment 402. Such IMU readings may be continually collected by associated hardware (e.g., accelerometers, gyroscopes and magnetometers) on board tags 404. The frequency of IMU data acquisition may range between one hertz to one kilohertz. In contrast, positional (e.g., B-HAP) measurements may occur less frequently, for example once every five seconds to five minutes. However, during the training phase, positional measurements may be used to teach the deep learning model to accurately interpret IMU data.

During the training phase, for each acquisition of position, many sets of IMU data may be collected. Each set of IMU data is associated with a specific point in time, forming a dense dataset of motion information that corresponds to the sparse positional measurements. Such an approach may minimize power consumption while providing that position updates used for training remain accurate and synchronized.

During the training phase, the deep learning model may learn to identify patterns and correlations between the IMU data and the corresponding positions of tags 404. This training process may enable the deep learning model to predict location of tags 404 based on IMU readings. By recognizing and correlating these patterns, the network can correct for drift and sensor noise, potentially providing more accurate position estimates without relying on traditional pedestrian dead reckoning (PDR) algorithms, as may be employed in conventional position tracking systems. For example, instead of manually estimating step length and heading, the deep learning model may capture these details inherently, processing them as part of its end-to-end learning approach. Such a method may allow the deep learning model to accurately infer position changes in real time, even during rapid movements or changes in user pace.

For scenarios involving multi-floor navigation, altitude accuracy may be further improved by integrating barometric sensor readings where available. The barometer data may enable the model to refine vertical position estimates, distinguishing between small height differences that may otherwise be lost in IMU data alone.

The completion of the training process may be determined by comparing positional coordinates predicted by the deep learning model from interpretation of the IMU readings with measured ground truth data. Training may be considered complete when the empirically obtained and predicted coordinates consistently agree within a predefined variance or tolerance. Once sufficient agreement between empirical and predicted data sets is established, confidence in the deep learning model’s ability to function without anchors may allow transition to a post-training phase of operation.

FIG. 4B illustrates an IPS network 400B, comprising interior environment 402. Within interior environment 402 are tags 404 and anchors 406. Tags 404 and/or anchors 406 communicate with gateway 408. In at least one embodiment, gateway 408 may communicate through cloud 410 with cloud server 412. In other embodiments, gateway 408 may communicate with local server 414. In IPS network 400B, while the number of tags 404 may be approximately the same as the number in IPS network 400A, fewer anchors 406 are deployed than were deployed in IPS network 400A. In some embodiments, no anchors are deployed. Anchors may be remotely deactivated in lieu of physical removal. In at least one embodiment, IPS network 400B represents a post-training phase of the deep learning model. In at least one embodiment, most or all of anchors 406 are removed or deactivated. IPS network 400B may be obtained by a seamless transition from IPS network 400A, with removal or deactivation of some or all anchors 406 and without requiring changes to the remaining hardware. The other components of IPS network 400A may remain in place for IPS network 400B. Thus, in at least one embodiment, some or all anchors may be temporarily deployed during the training phase, and physically removed or deactivated during the post-training operational phase.

In at least one embodiment, the deep learning model maintains control over tags 404 during the post-training operational phase represented by IPS network 400B. While reliance on anchors 406 is significantly reduced or eliminated in the post-training phase, the deep learning model may lose accuracy over time as conditions may change within interior environment 402. In such a situation, anchors 406 may be reconfigured and added to IPS network 400B to retrain the model. Thus, IPS network 400B may remain adaptable to changing conditions.

To reduce power consumption by IPS network 400B, data compression may be applied prior to transmission in some embodiments, further decreasing the data payload. In other embodiments, local processing on the tags 404 may also aid in reduction of data transfer. For example, pre-processing tasks such as step detection or heading (e.g., direction) estimation can be performed directly on tags 404, which may significantly reduce the amount of raw data sent to the deep learning model. Strategies such as those enumerated herein may collectively enhance the efficiency of IPS network 400B, while maintaining the accuracy and synchronization of location updates. In addition, because of the large volume of IMU data that can be acquired by the deep learning model, IPS network 400B may adjust data transmission to the cloud through a combination of techniques aimed at minimizing bandwidth usage and power consumption. In some embodiments data filtering is employed to transmit significant changes in motion or orientation, rather than sending every IMU reading on a continuous basis. Employment of data filtering may reduce transmission or transfer of redundant or insignificant data while preserving relevant information.

In at least one embodiment, IPS network 400B may also use non-B-HAP devices (e.g., ultra-wideband (UWB), radar, visual, motion capture, etc.) in fixed, known locations to provide Opportunistic Location Refinement to the deep learning model. For example, when a tag interacts with a door reader at an entrance or exit, or when a user logs in at a specific workstation, these interactions provide highly accurate location information that can be used to refine the location estimates computed by the deep learning model.

In some embodiments, the deep learning model may compensate for changes in how tags 404 are deployed, for example, how they are worn or positioned by a user, such as being placed in a pocket instead of worn on a lanyard. By adjusting weights applied to different IMU inputs or learned feature representations, the deep learning model may preserve positional reliability despite variations in tag placement. This adaptability may allow the model to consistently track user movement patterns and maintain positional accuracy even when user behaviors or environmental conditions shift unpredictably.

FIG. 4C illustrates a block diagram 400C of an electronic circuit onboard tag 404, in accordance with at least one embodiment. Block diagram 400C comprises processor 420. In at least one embodiment, an inertial measurement unit (IMU) 422 is coupled to processor 420. In at least one embodiment, IMU 422 comprises an accelerometer 424, a gyroscope 426 and a magnetometer 428. In some embodiments, magnetometer 428 is optionally included. In at least one embodiment, block diagram 400C includes a transceiver 430 coupled to processor 420. Arrows indicate direction of information flow. For example, processor 420 has a two-way communication link with transceiver 430, which may receive data from processor 420 to transmit, and sends data to processor 420 when data is received. Processor 420 may have a one-way communication link with IMU 422, where processor 420 receives data from IMU 422.

In at least one embodiment, tag 404 includes a power source 432, which is connected with processor 420, transceiver 430 and IMU 422. In at least one embodiment power source 432 is portable. For example, power source 432 may be a battery or a wireless inductive power source.

FIG. 4D illustrates a block diagram 400D of an electronic circuit onboard anchor 406, in accordance with at least one embodiment. Block diagram 400D comprises a processor 434 and a transceiver 436 coupled to processor 434. In at least one embodiment, block diagram 400D comprises a power source 438 connected to processor 434 and transceiver 436. As was described for tag 404, an example of power source 438 may be a battery.

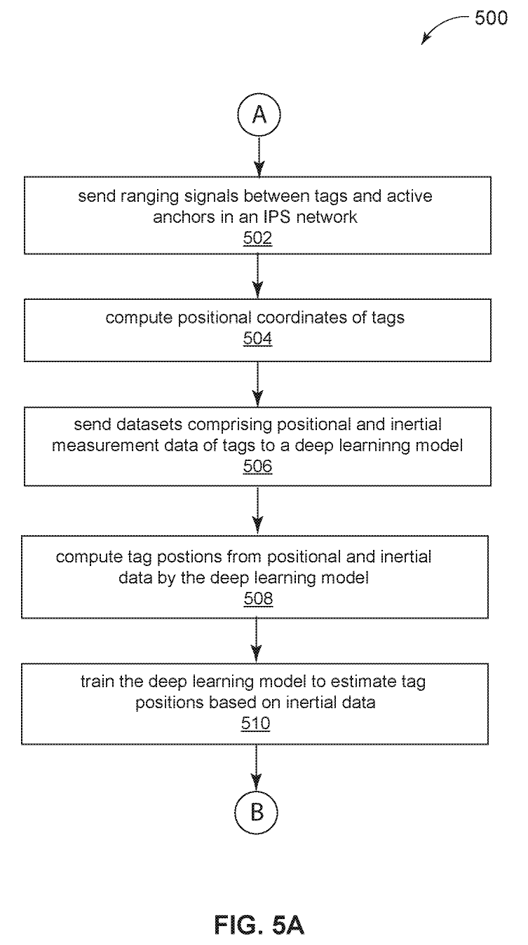

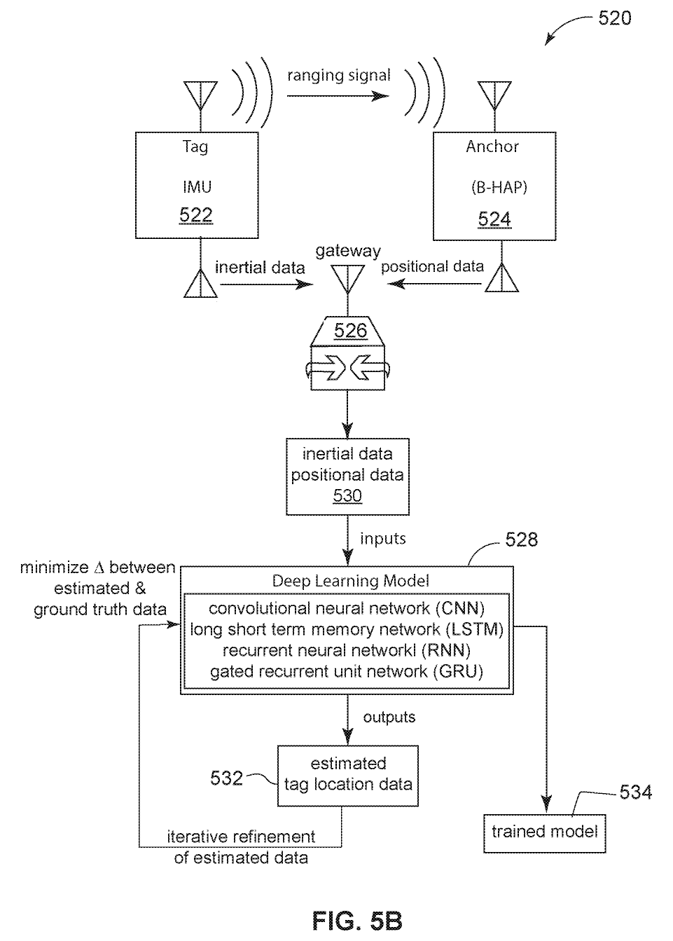

FIG. 5A illustrates a flowchart 500 summarizing a method for operation of an IPS network in a training phase, for example, IPS network 400A, in accordance with at least one embodiment. The IPS network comprises an interior environment, such as interior environment 402, shown in FIGS. 4A and 4B, a plurality of anchors, such as anchors 406, deployed within the interior environment. IPS network 400A comprises a gateway system (e.g., a router) that may enable access to the internet, or to a local area network (LAN). IPS network 400A may further comprise a computing network, for example, having distributed computing systems on tags and anchors. Distributed computing systems may comprise one or more processors and memory. In at least one embodiment, the computing network may comprise a cloud server, such as cloud server 412, and optionally a local server, such as local server 414.

The computing network may employ wireless connectivity and/or telemetry platforms, such as Bluetooth, Wi-Fi, Zigbee, ANT, LoRa, Wireless USB, Thread Mesh Networking and other short-range wireless networking platforms. Some networking platforms may not have direct access to the internet but may work in tandem with Wi-Fi or Bluetooth to provide access to the internet. In some embodiments, anchors and servers may be connected into the computing network by Ethernet wired connectivity. In at least one embodiment, the gateway may be a centralized device, such as a router or access point, with which all tags and/or anchors communicate. In other embodiments, the gateway may be distributed onboard tags and/or anchors.

For example, as noted above, tags may have onboard processors and onboard wireless transceivers coupled to the onboard processors, where onboard transceivers may transmit and receive signals and data wirelessly, as tags are generally mobile. In some embodiments, tags may also have onboard gateway (e.g., router) hardware. Thus gateway 408 in FIGS. 4A and 4B may be a general representation of access to the internet regardless of type of deployment. For example, gateway hardware may be contained within a single enclosure, or distributed in tags and/or anchors. While cloud 410 in FIGS. 4A and 4B may generally represent the internet, it may also represent a LAN. Anchors may be configured to receive data from tags. For example, anchors may receive ranging signals generated by B-HAP (or other high-accuracy positioning)-enabled hardware and software onboard tags. Anchors may process the ranging signals, for example, using AoA techniques (see above) or RTT, RSSI, and/or ToF techniques as well, to determine position of a tag transmitting the ranging signal. Conversely, AoD techniques may also be used if tags are configured to receive ranging signals transmitted by anchors. In other embodiments, IMU telemetry data, providing motion-related information of mobile tags, may be transmitted by tags and received by anchors. In some embodiments, anchors may pass data to the deep learning model via a gateway to the cloud server (e.g., cloud server 412), or to a local server (e.g., local server 414), where the servers may run deep learning model algorithms.

Initially, tags (e.g. tags 404) are deployed to personnel or mobile objects, such as merchandise in a warehouse or factory, in an interior environment, such as interior environment 402. In some embodiments, interior environment 402 may be a hospital, shopping center, department store, school, office building, sport center, vacation resort, factory, warehouse, etc. For example, identification devices such as RFID tags may be attached to objects for tracking. A plurality of anchors may be deployed within the interior environment at fixed positions. The fixed position coordinates of some or all the individual anchors may be stored in a memory accessible to the deep learning model. In some embodiments, some of the anchors may also be mobile.

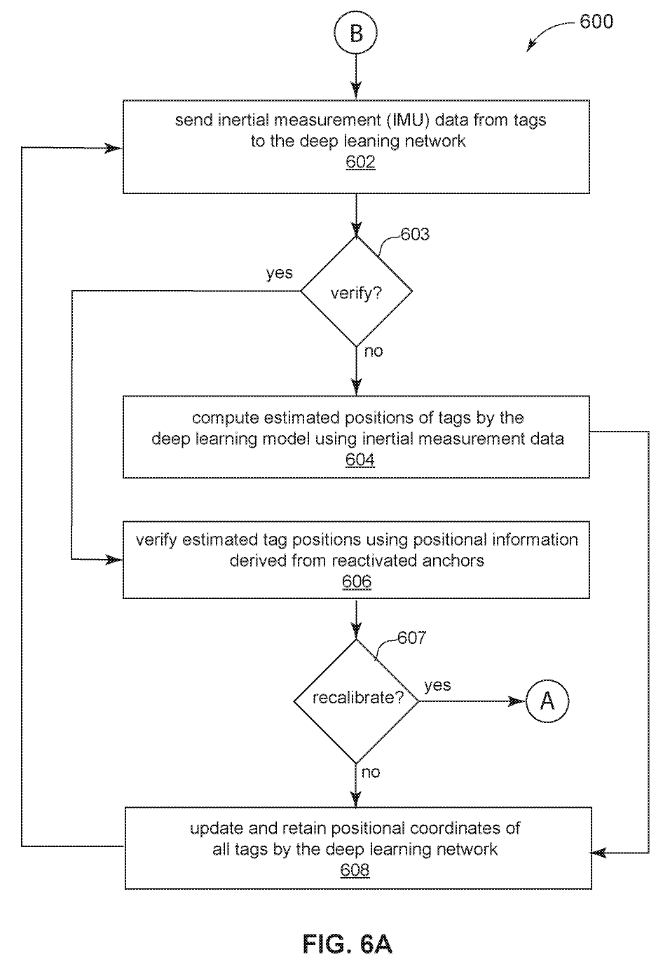

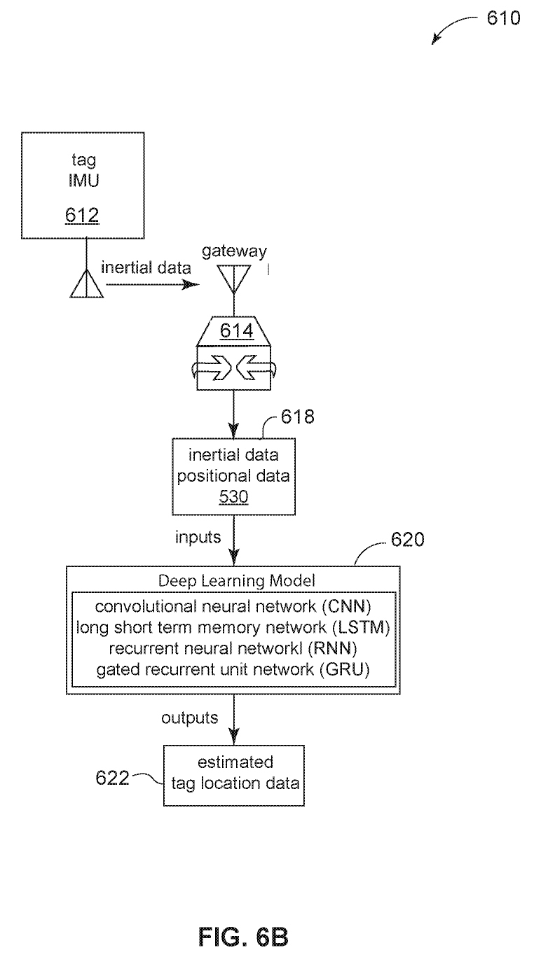

Flowchart 500 begins at the link labelled “A”, which serves as a link point for redirection from a post-training phase for recalibration purposes, such as is illustrated by flowchart 600 in FIG. 6A.

At operations 502 and 504, tags within the interior environment transmit IMU telemetry data and a ranging signal to anchors deployed within the interior environment, according to at least one embodiment. In at least one embodiment, anchors may perform computations by onboard computing systems comprising onboard processors. In further embodiments, anchors may contain gateway hardware as part of the onboard computing systems, enabling transfer of computed positional data (of tags) to a cloud server or a local server in a LAN running deep learning model software algorithms. The transferred data may be the positional data of the tags that are derived from ranging signals.

The algorithms computing the positional data may be separate from deep learning model algorithms. For example, software running on anchor-based processors may perform computations using RSSI, RTT, PBR and/or AoA/AoD calculations. Other more generic techniques may be implemented, such as equivalent versions of phase ranging, time of flight, round-trip time, AoA and AoD found in Bluetooth Core 5.1 and later specification suites. For example, Wi-Fi-based IPS networks may estimate location of tags using signal measurements from access points (APs). Other implementations may include RSSI fingerprinting, which compares real-time signals to a pre-mapped database, while position may be estimated using signal strength- or angle-based measurements. Time Difference of Arrival (TDoA) may also be implemented, where arrival time differences may be measured across synchronized APs. For example, the IEEE 802.11mc specification includes a method similar to RTT, with improved accuracy, although in some implementations it may rely on a dense AP network.

UltraWideband (UWB) may offer centimeter accuracy using high-frequency pulses and time-based techniques. Similarly, equivalent methodologies employing ToF, TDoA or other techniques may also be incorporated into UWB.

Radar sensors may also be employed to obtain ranging and directional information. Finally, non-radio frequency devices may be employed, such as visual sensors and cameras for machine vision, LiDAR sensors for obtaining three-dimensional information about the interior environment, motion capture with precise timing, geomagnetic field approaches, and particle filtering with wall and obstruction sensing. IMU data may be used to estimate motion-related information, such as displacement, heading, velocity, and/or movement state. Accelerometer and gyroscope data may be used for techniques such as step detection and/or Pedestrian Dead Reckoning (PDR), which may be used to estimate displacement of a mobile object, person, or animal.

In other implementations, Known-Position Radio-Based equipment may be employed. For example, devices such as near-field communication (NFC)-enabled locks (e.g., smart locks), infrared transceivers, or RFID readers can provide accurate checkpoint-based location data. Systems such as these may be used for verifying or resetting a user’s position when passing through known checkpoints, such as doors, turnstiles, designated zones, etc.

At operations 506 and 508, data from anchors are transferred to the deep learning model algorithms that may be running on a cloud server and/or the local server. Network connectivity may be enabled by wired or wireless gateways, such as Wi-Fi routers, deployed within the interior environment to provide internet access. In other embodiments, a wired or wireless local area network (LAN or WLAN) may be deployed within the interior environment for non-internet connectivity. In a LAN configuration, one or more routers may connect anchors and/or tags to a local server bypassing access to the internet. In some implementations, a LAN may provide greater security.

Data sent to the deep learning model may comprise training datasets comprising tag positional coordinates computed by anchors, tags, gateways, and/or servers based on ranging signals. Inertial data in the form of IMU telemetry data may be combined with positional data to provide training datasets sent to the deep learning model. In at least one embodiment, the deep learning model may comprise a neural network architecture, such as a recurrent neural network (RNN), long short-term memory (LSTM) network, or convolutional neural network (CNN), configured to learn correlations between the inertial measurement telemetry data and the positional coordinates of the portable locator tag. In at least one embodiment, tag-borne accelerometers, gyroscopes, and magnetometers may generate raw inertial data that may be sent to anchors in telemetry streams, where anchor-borne processors may operate on such data to estimate motion-related information of the tags, which may be formed into inertial datasets. These inertial datasets may be packaged with positional data of tags to provide the training datasets for the deep learning model. In some embodiments, anchors may relay the training datasets to gateways, which in turn may transfer the training datasets to servers hosting the deep learning model. Results of positional and/or IMU calculations performed by a local server may be transferred to a cloud server for storage or modeling.

At operation 510, in at least one embodiment, the deep learning model may perform statistical correlation computations to find relational information between positional data and inertial data in each training dataset, to develop reliable position maps for the ensemble of tags. The ground truth mapping may be updated at desirable intervals, such as every minute or every five minutes, to obtain accurate ground truth data on tag movement. The deep learning model may learn relationships and patterns between position and movement-related information inferred from inertial data) of tags, where an average ground truth picture may emerge. The ground truth maps may be correlated with time of day, day of week, etc.

Based on the development of reliable ground truth mapping, the deep learning model may learn to autonomously estimate positional information of tags based on the inertial data alone, with reduced reliance on anchors to determine positional data for tags. In at least one embodiment, the learning phase may be verified for accuracy by testing the IPS network after a designated training period by comparing estimated tag positional data of tags to ground truth data formed by measured positional data.

FIG. 5B illustrates a flowchart 520, summarizing an example of a training phase system is described in the following paragraphs. Flowchart 520 is an expansion of operation 510 of flowchart 500.

In at least one embodiment, during a training phase, a tag 522 carried by a person or associated with a mobile object traverses an interior environment while one or more inertial sensors onboard the tag generate time-series inertial measurement data. The inertial measurement data may comprise accelerometer data, gyroscope data, and, in some embodiments, magnetometer data and/or barometric data. At corresponding times, one or more anchors 524 deployed at known positions within the interior environment may determine ground truth position coordinates of the tag using one or more radio-based positioning techniques, such as angle-based measurements, ranging measurements, or combinations thereof. Positional data may be transmitted to gateway 526, which may have a cloud or LAN connection.

In at least one embodiment, the system may associate a time window of inertial measurement data with corresponding ground truth position coordinates of the tag to form a training sample. A plurality of such training samples may be provided to the deep learning model 528 in the form of training datasets 530, such that the deep learning model 528 learns a relationship between the inertial measurement data and position-related inputs. In some embodiments, the position-related inputs may comprise absolute position coordinates, relative displacement, heading, velocity, altitude, floor level, or combinations thereof. Inertial-related inputs may comprise heading and velocity data derived from accelerometric, gyroscopic and/or magnetometer measurements. In some embodiments, the inertial measurement data and the ground truth position coordinates may be synchronized by timestamps, sample indices, interpolation, and/or other temporal alignment techniques.

In at least one embodiment, the deep learning model 528 may employ neural networks such as a convolutional neural network (CNN), recurrent neural network (RNN), a Long Short Term Memory network (LSTM), or a gated recurrent unit network (GRU). These networks may be employed in any combination to process the input data. In at least one embodiment, the deep learning model 528 may be trained by providing inertial measurement data as input to the neural network or neural networks employed, generating one or more predicted position-related outputs 532, comparing the one or more predicted position-related outputs to corresponding ground truth position coordinates or derivatives thereof, and iteratively updating parameters of the deep learning model to reduce prediction error. In some embodiments, the prediction error may be based on differences between predicted and ground truth coordinates, displacement, heading, trajectory, altitude, floor classification, or combinations thereof. In some embodiments, training may be performed using batches of training samples collected from one or more tags over one or more traversals of the interior environment.

In at least one embodiment, after the training phase is completed, the trained deep learning model 534 may receive inertial measurement data generated by the tag during movement through the interior environment and may output estimated location information for the tag based on the learned relationship between the inertial measurement data and the ground truth position coordinates used during training. In some embodiments, the estimated location information may comprise current position, change in position, predicted trajectory, floor level, and/or other position-related information. In some embodiments, the estimated location information may be generated with reduced or no reliance on the full set of anchors used during training.

Once training is completed, the post-training phase may be entered. A transition to a post-training phase is indicated by the link labelled “B” at the end of operation 510, indicating continuation to flowchart 600, describing operations conducted during the post-training (e.g., routine) phase of operation of the IPS network. In at least one embodiment, one or more anchors may remain deployed after training and may provide intermittent or supplemental position-related measurements to verify, refine, reset, and/or recalibrate estimated location information generated by the deep learning model. In this manner, the disclosed IPS may operate in a training mode in which anchor-derived ground truth data and inertial measurement data are jointly used to train the deep learning model, and in a post-training mode in which the deep learning model estimates location from inertial measurement data alone or from inertial measurement data in combination with measurements from one or more remaining anchors.

FIG. 6A illustrates a flowchart 600 summarizing a method for operation of an IPS network in a post-training phase of operation (e.g., routine operation), in accordance with at least one embodiment. The method described refers to the IPS network configuration (e.g., IPS network 400B) shown in FIG. 4B. Here, the number of anchors compared to the IPS network shown in FIG. 4A (e.g., IPS network 400A) has been significantly reduced. In at least one embodiment, as previously noted, during routine operation (e.g., post-training phase of operation) some or all anchors may be physically removed from the interior environment, or deactivated. Deactivated anchors may be reactivated at any time for re-calibration (e.g., retraining of the deep learning model) or verification of estimated position information. Flowchart 600 begins at the link labelled “B”, which may indicate a point of entry to flowchart 600 from flowchart 500 when the training phase transitions to the post-training phase of operation.

At operation 602, tags transmit IMU data to a server running the deep learning model algorithms. As noted above, the server may be a cloud-based server (e.g., cloud server 412) or a local server (local server 414). The IMU data may be sent by telemetry streams derived from IMU-generated datasets. These data may be received and processed by the deep learning model, which has been trained during the training phase illustrated in flowchart 500, where training data comprising combined positional data (e.g., x, y and z) for tags and IMU training data were sent from anchors to the deep learning model. In at least one embodiment, some or all anchors are removed or deactivated during the post-training phase of operation. Deactivated anchors may be virtually removed but not physically removed from the IPS network. Deactivated anchors may be reactivated for verification and recalibration purposes.

In some implementations of the IPS network, the correlations between ground truth (positional) data for tags and IMU data sent by some or all the tags in the ensemble of tags may change over time. For example, the topology or configuration of the interior environment may change, in that previous configuration is modified by additions or subtractions of structures, such as walls, partitions, furniture, floors, etc. In logistical implementations for factories and warehouses, changes in placement of equipment, additions or removal of assembly line machinery, building remodels, etc. may warrant a retraining of the deep learning model to recalibrate the IPS network. In other implementations, movement patterns of personnel, animals or mobile inanimate objects may change over time. For example, addition of a new store in a shopping mall, a change in location of equipment, breakrooms, restrooms in a workplace environment may change correlations between IMU-determined movement patterns and anchor-derived training position information to the point where the IPS network may require recalibration. Thus, the IPS network may be recalibrated to maintain accurate position estimation from IMU data, with reduced or no reliance on independent positional determinations (e.g., AoA, AoD, RSSI, RTT, ToF, etc.). In some embodiments, periodic verification of the accuracy of the post-training operation of the IPS network may be undertaken to determine whether a recalibration may be necessary. In some embodiments, a decision node 603 is shown in flowchart 600, where a decision may be made to temporarily direct flow from routine operation to a verification procedure. If no verification procedure is requested, flow may be directed to operation 604. If a verification process is requested, flow may then be directed to operation 606, bypassing operation 604. As previously noted, if verification is not requested, flow may continue to operation 604.

At operation 604, the deep learning model computes instantaneous position estimates for tags in the IPS network. The estimated position data may be updated at desired intervals (e.g., see operation 608). In at least one embodiment, the computations may be based on correlations between ground truth data (e.g., positional data of tags) and IMU data sent during the training phase. For example, during routine operation, the deep learning model may dynamically compute tag positions by real time correlations with dynamic IMU data sent from tags to the deep learning model. Flowchart 600 may continue to operation 608, bypassing operation 606 if a verification procedure has not been requested.

At operation 606, a verification procedure may be activated to determine the accuracy of the ground truth information for the ensemble of tags. In some embodiments, verification may be performed on a periodic basis or at desired intervals. In some embodiments, anchors that had been previously removed physically or virtually may be reinstalled or reactivated. Tags may be programmed to transmit ranging signals that can be received by anchors for positional computations as done in the training phase. For example, tags may transmit their IMU data simultaneously with a ranging signal to anchors, so that positional/IMU datasets can be sent to the deep learning model by anchors as done during the training phase.

In some embodiments, new ground truth information may be obtained during the verification procedure, as well as updated correlations between ground truth data and IMU data. The new ground truth data obtained during the verification procedure may be compared with pre-verification position estimates obtained during routine operation (e.g., operation 604). If differences are detected, then a recalibration procedure may be activated to retrain the deep learning model based on current conditions within the interior environment.

If recalibration of the IPS network is to be undertaken due to detection of differences, flowchart 600 may be interrupted to redirect the flow to a sequence of operations similar to IPS network 400A. For example, this procedure is shown by link labelled “A” in flowchart 600, where such a decision is invoked at decision point 607. If a difference between ground truth determined during the verification procedure and position estimates obtained during routine operation is detected and is determined to be sufficient (e.g., by internal criteria) to initiate a recalibration, flow may then be redirected to flowchart 500 at decision point 607. When recalibration is complete (e.g., end of flowchart 500 is reached), flow may be redirected to the top of flowchart 600, as indicated by the link labelled “B”. The deep learning model may now autonomously compute position estimates for the interior environment with a greater degree of confidence based on IMU data generated by the ensemble of tags than in the prior post-training phase of operation. However, if a difference is detected but does not meet criteria to initiate recalibration, flow may continue to operation 608.

At operation 608, the cloud server and/or local server may store updated autonomously determined position coordinates of the ensemble of tags within the internal environment to maintain current estimated position data at desired intervals. For example, updates may occur at intervals of one minute, five minutes, etc. After an update is completed, flow may return to operation 602 to continue the determination of position estimates for the IPS network on a cyclical basis, with verification occurring at desired intervals built into the process flow.

In some embodiments, some parts or all software components of the deep learning model may reside within onboard hardware contained within the tags, thus potentially reducing or eliminating communication with external servers. Such an architecture for the IPS network may be advantageous regarding, for example, data privacy or low-latency processing.

FIG. 6B illustrates a flowchart 610, summarizing an example of a post-training phase system comprising trained neural networks described above, is described in the following paragraphs. Flowchart 610 is an expansion of operation 604 of flowchart 600.

In at least one embodiment, tag 612 is carried by a person or associated with a mobile object as during the training phase. The person or object traverses an interior environment while one or more inertial sensors onboard the tag generate time-series inertial measurement data. The inertial measurement data is generated by IMU systems onboard tags 612, and may comprise accelerometer data, gyroscope data, and, in some embodiments, magnetometer data and/or barometric data. Tag 612 may transmit inertial data 618 to gateway 614 at intervals that enable the deep learning model 620 to perform timely updates of tag positions. In the post-training operational phase (e.g., routine or “live” operation), some or all anchors have been removed or deactivated, thus, in some embodiments, at least some of the anchors are temporarily deployed for training purposes. In some embodiments, most anchors have been physically removed, and some may remain at strategic locations in a deactivated state. Remaining anchors that are deactivated may later be re-activated for verification of accuracy of estimated location data, and for occasional retraining of the model.

In at least one embodiment, neural networks within deep learning model 620 have been trained to associate inertial data during the training phase shown in FIGS. 5A and 5B. Based on updated inertial data inputs to the trained deep learning model 620, outputs of estimated tag location data 622 may be obtained to yield estimated locations of tags based on the inertial data generated by the IMU systems onboard tags 612.

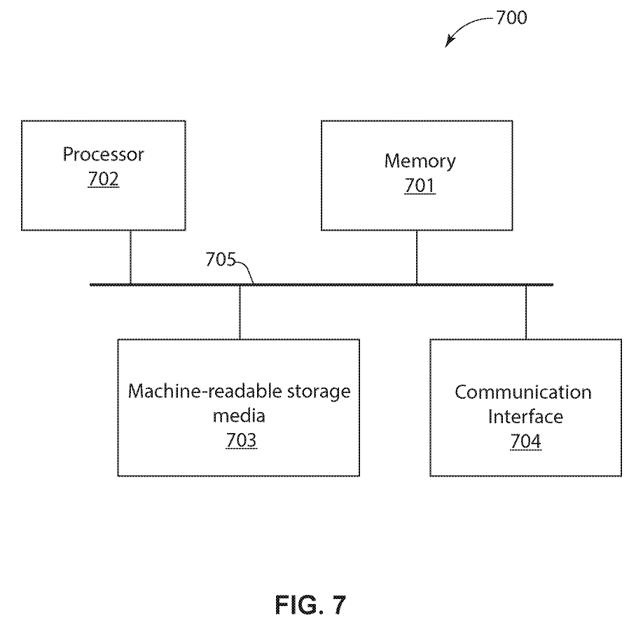

FIG. 7 illustrates processor system 700 with a machine-readable storage medium having machine-readable instructions that when executed cause a microcontroller (e.g., processor 702) in a circuit board of a control unit for tag 404, anchor 406, servers 412 or 414, to execute the machine-readable instructions according to methods of flowcharts 500 and 600, in accordance with at least one embodiment. Processes described in various embodiments of the present disclosure may be stored in a machine-readable storage medium (e.g., 703) as computer- executable instructions. A machine-readable storage medium may be random access memory (RAM), for example. In at least one embodiment, processor system 700 comprises memory 701, processor 702, machine-readable storage medium 703 (also referred to as tangible machine-readable medium), communication interface 704 (e.g., wireless or wired interface), and network bus 705 coupled together.

In some embodiments, processor 702 is a Digital Signal Processor (DSP), an Application Specific Integrated Circuit (ASIC), a general-purpose Central Processing Unit (CPU, e.g., processor 420), or a low power logic implementing a simple finite state machine to perform various processes described herein.

In some embodiments, machine-readable storage medium 703 includes instructions for receiving ranging signals, processing inertial measurement data, determining position-related data, and executing one or more functions of the deep learning model, as described above with reference to various embodiments. In some embodiments, the various logic blocks of processor system 700 are coupled together via network bus 705. Any suitable protocol may be used to implement network bus 705.

In one example, machine-readable storage medium 703 is a machine-readable storage medium with instructions for measuring angle of arrival (AoA) and/or determining round-trip time (RTT) associated with ranging signals exchanged between tags 404 and anchors 406. Machine-readable storage medium 703 has machine-readable instructions that, when executed, cause processor 702 to perform the method with reference to various embodiments.

Program software code/instructions associated with various embodiments may be implemented as part of an operating system or a specific application, component, program, object, module, routine, or other sequence of instructions or organization of sequences of instructions referred to as "program software code/instructions," "operating system program software code/instructions," "application program software code/instructions," or simply "software" or firmware embedded in a processor. In some embodiments, the program software code/instructions associated with processes of various embodiments are executed by processor system 700.

In some embodiments, machine-readable storage medium 703 is a computer executable storage medium. In some such embodiments, the program software code/instructions associated with various embodiments are stored in computer executable storage medium 703 and executed by processor 702. Here, computer executable storage medium 703 is a tangible machine-readable medium 703 that can be used to store program software code/instructions and data that, when executed by a computing device, causes one or more processors (e.g., processor 702) to perform a process.

The tangible machine-readable medium 703 may include storage of the executable software program code/instructions and data in various tangible locations, including for example, ROM, volatile RAM, non-volatile memory and/or cache and/or other tangible memory as referenced in the present application. Portions of this program software code/instructions and/or data may be stored in any one of these storage and memory devices. In some embodiments, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions associated with the various embodiments can be obtained in their entirety prior to the execution of a respective software program or application. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine-readable medium 703 in entirety at a particular instance of time.

Examples of tangible machine-readable medium 703 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMs), Digital Versatile Disks (DVDs), etc.), among others. The software program code/instructions may be temporarily stored in digital tangible communication links while implementing electrical, optical, acoustical, or other forms of propagating signals, such as carrier waves, infrared signals, digital signals, etc. through such tangible communication links.

Here, some methods and devices may be shown in block diagram form, rather than in detail, to avoid obscuring present disclosure. Reference throughout this specification to “an implementation,” “one implementation,” or “some implementations” means that a particular feature, structure, function, or characteristic described in connection with an example is included in at least one example of disclosure. Thus, appearances of the phrase “in an implementation,” “in one implementation,” “in at least one implementation,” or “some implementations” in various places throughout this specification are not necessarily referring to same example of disclosure. Furthermore, particular features, structures, functions, or characteristics can be combined in any suitable manner in one or more examples. For example, a first example can be combined with a second example anywhere particular features, structures, functions, or characteristics associated with two examples are not mutually exclusive. A list of definitions follows, whereby the following definitions may provide or augment literal support for claims.

As used herein, singular forms “a,” “an,” and “the” are intended to include plural forms as well, unless context clearly indicates otherwise. It will also be understood that the term “and/or” as used herein refers to and encompasses one or more combinations of one or more of associated listed items.

Here, “coupled” and “connected,” along with their derivatives, may be used to describe functional or structural relationships between components. These terms are not intended as synonyms for each other. Rather, in particular examples, “connected” may be used to indicate that two or more elements are in direct physical, optical, or electrical contact with each other. “Coupled” may be used to indicate that two or more elements are in either direct or indirect (with other intervening elements between them) physical, electrical, or magnetic contact with each other, and/or that two or more elements cooperate or interact with each other (e.g., as in a cause-and-effect relationship). “Coupled” may also include non-mechanical contact or connection. “Coupling” may also mean thermal connectivity, where one object may be a heat source and another object may be a heat sink, either in thermal equilibrium with each other or subject to a common conductive, convective, or radiative heat flow between them; electrical coupling, where objects may be connected electrically in an electric or electronic circuit and a current flow may be induced by application of a voltage between the electrically interconnected objects or by an electric field between mechanically coupled or isolated objects; magnetic coupling, where two mechanically coupled or isolated objects mutually share a common magnetic field flux; and fluidic coupling, where objects such as vessels and conduits may share a common gas or liquid fluid that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis, or y-axis of a device. A material that is between two other materials may be in contact with one or both of those materials. In another example, a material that is between two or more materials may be separated from both of the other two materials by one or more intervening materials. A material “between” two other materials may therefore be in contact with either of the other two materials. In another example, a material “between” two other materials may be coupled to the other two materials through an intervening material. A device that is between two other devices may be directly connected to one or both of those devices. In another example, a device that is between two other devices may be separated from both of the other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by the term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” the second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one example, such variation may be no more than +/-10% of referred value.

Here, “Indoor Positioning System (IPS)” may generally refer to a system that tracks and monitors the location of objects or people within an indoor space using technologies such as Bluetooth, Ultra-Wideband (UWB), Wi-Fi, RFID, NFC, and others. In one example, an IPS may employ techniques such as triangulation (using angles), trilateration (using distances to three points), and multilateration (using distances to four or more points) to determine position information.

Here, “Inertial Measurement Unit (IMU)” may generally refer to a device comprising a gyroscope, an accelerometer, and/or a magnetometer, used to measure motion and orientation. In one example, IMU data may be telemetry data that is digitized and transmitted over an RF link.

Here, “IMU telemetry data” may generally refer to telemetry comprising inertial measurement data generated by one or more inertial sensors of individual tags within an IPS network. In some embodiments, motion-related information, such as displacement, heading, velocity, orientation, and/or movement state, may be estimated from the IMU telemetry data.

Here, “Received Signal Strength Indicator” (RSSI) may generally refer to a measurement of the power level of a received radio signal, which may be used in wireless systems for distance estimation, fingerprinting, and/or other position-determining techniques. In an example, RSSI-based systems are simple but can suffer from interference and variability.

Here, “Angle of Arrival (AoA)” may generally refer to computational methods that determine the direction of propagation of a (short range) radio frequency ranging signal that is emitted from a mobile transmitter by determining the angle at which the signal arrives at a fixed receiver. In at least one example, the angle of arrival is computed in relation to an orientation of the receiver.

Here, “Angle of Departure (AoD)” may generally refer to computational methods that determine direction information associated with a short-range radio frequency ranging signal transmitted by a fixed transmitter and received by a mobile receiver. In one example, AoD information may be used for angle-based position determination.

Here, “Phase-Based Ranging (PBR)” may generally refer to a ranging technique that calculates distance between a receiver and a transmitter by analyzing phase differences in signals exchanged across multiple frequencies, often achieving sub-meter accuracy. In one example, PBR information may locate the position of the transmitter by trilateration or multilateration by analyzing the data from at least three receivers.

Here, “Round Trip Time (RTT)” may generally refer to a ranging technique that calculates distance by measuring the time it takes for a signal to travel from a transmitter to a receiver and back, offering high accuracy in complex environments. In one example, RTT information may locate the position of the transmitter by trilateration or multilateration by analyzing the data from at least three receivers.

Here, “Bluetooth High-Accuracy Positioning (B-HAP)” may generally refer, as used herein, to a collective term for Bluetooth-based wireless positioning technologies, including, for example, Angle of Arrival (AoA), Angle of Departure (AoD), phase-based ranging (PBR), and/or round-trip time (RTT), as well as related proprietary or custom implementations. In some embodiments, B-HAP may include Bluetooth Direction Finding features, such as AoA and/or AoD, and/or Bluetooth Channel Sounding features described in Bluetooth Core Specification v6.0, such as PBR and RTT-based distance-bounding functionality. Reference by acronym or abbreviation for specific positioning techniques (e.g., AoA, AoD, PBR, RTT, ToF) may apply to Bluetooth-based radio-frequency technology and may more broadly apply to similar methods included in other wireless specifications or obtainable by custom or open-source wireless technology.

Here, “deep learning” may generally refer to asubset of machine learning that uses artificial neural networks to process and analyze information.

Here, “deep learning model” may generally refer to machine learning algorithms based on multi-layered artificial networks (e.g., four or more layers, generally of artificial neural networks) that are inspired by the architecture of the human brain. In one example, deep learning models are designed to analyze complex, unstructured data. In one example, deep learning models may be configured to extract features from large datasets enabling high performance computations for computer vision and generative artificial intelligence (AI).

Here, “ground truth” may generally refer to information that is known to be real or true, provided by direct observation and measurement (e.g., empirical evidence) as opposed to information provided by inference.

Here, “ground truth data” or "ground truth information” may generally refer to empirically determined positional information of, for example, tags in an interior environment.

Here, "interior environment” may generally refer to an indoor environment, such as the interior of a building.

Here, “tag” or “portable locator tag” may generally refer to a device equipped with Bluetooth or other RF positioning technologies and an inertial measurement unit. Examples of tags may include smart cards, RFID cards or other interrogatable tags, wearables, asset trackers, and badges. Tags may include B-HAP or equivalent capabilities, and may include other technologies used in the IPS. Tags may include processing system hardware capable of executing modules of software containing functional instructions for a deep learning model. Some or all software modules of the deep learning model may be stored within the processing system onboard the tag.

Here, “anchor” may generally refer to stationary devices capable of transmitting or receiving signals for location determination. Anchors may utilize B-HAP or other radio technologies and are typically used during real-time localization or training phases.

Here, “Opportunistic Location Refinement” may generally refer to a technique that leverages the known locations of fixed devices (e.g., door readers, computers) with which tags interact to generate ground truth data. This data may then be used to continuously refine the deep learning model's IMU-derived location estimates.

Here, “trilateration” may generally refer to a geometric technique for determining the location of an object in two-dimensional space using its distances to three known points.

Here, “multilateration” may generally refer to a method for determining the three-dimensional coordinates of an object by measuring its distances to at least four reference points with known locations.

Here, “angulation” may generally refer to a geometric technique for determining the location of a point using angles from the point to known reference points.

Here, “administrative services” may generally refer to tags controlled by a centrally administered service that can manage tags in an installation (e.g., an IPS network) as a group or subgroup. In an example, administrative services may also manage a single tag in an installation. In an example, connectivity from the administrative services to tags can be made by some combination of Wi-Fi, Bluetooth, USB, and/or NFC.

In the following paragraphs, examples are provided that illustrate various examples. Examples can be combined with other examples. As such, various examples can be combined with other examples without changing scope of disclosure.

Example 1 is an indoor positioning system network, comprising: a portable locator tag comprising a first transceiver and an inertial measurement unit (IMU), wherein the first transceiver is configurable to transmit or receive a ranging signal and to transmit a set of inertial measurement telemetry data, wherein the set of inertial measurement telemetry data is based on the inertial measuring unit (IMU); and one or more reference anchors comprising a second transceiver configurable to receive the ranging signal from the first transceiver, wherein the ranging signal is to be processed to produce a set of positional coordinates of the portable locator tag.

Example 2 is an indoor positioning system network according to any example herein, in particular example 1, further comprising a server configurable to execute a set of software instructions of a deep learning model stored within a memory accessible by the server.

Example 3 is an indoor positioning system network according to any example herein, in particular example 2, wherein the deep learning model is configured to process a plurality of training datasets in a training phase of operation.

Example 4 is an indoor positioning system network according to any example herein, in particular example 3, wherein the plurality of training datasets comprises a training set of ground truth positional coordinates of the portable locator tag and the set of inertial measurement telemetry data generated by the IMU onboard the portable locator tag.

Example 5 is an indoor positioning system network according to any example herein, in particular example 4, wherein the deep learning model is configured to learn to correlate the set of inertial measurement telemetry data with the set of positional coordinates of the portable locator tag during the training phase of operation.

Example 6 is an indoor positioning system network according to any example herein, in particular example 5, wherein the deep learning model is configured to predict an operational set of positional coordinates of the portable locator tag based on a set of correlations learned during the training phase of operation and based on sets of operational inertial measurement telemetry data in a post-training phase of operation.

Example 7 is an indoor positioning system network according to any example herein, in particular example 1, wherein the portable locator tag comprises a first processor, wherein the first transceiver is coupled to the first processor, wherein the IMU is coupled to the first processor.

Example 8 is an indoor positioning system network according to any example herein, in particular example 7, wherein the IMU comprises any one of an accelerometer or a gyroscope coupled to the first processor.

Example 9 is an indoor positioning system network according to any example herein, in particular example 7, wherein the IMU comprises a magnetometer coupled to the first processor.

Example 10 is an indoor positioning system network according to any example herein, in particular example 7, wherein the one or more reference anchors comprise a second processor, wherein the second transceiver is coupled to the second processor.

Example 11 is an indoor positioning system network according to any example herein, in particular example 2, wherein the server is a cloud server, wherein the cloud server is part of a cloud network.

Example 12 is an indoor positioning system network according to any example herein, in particular example 11, further comprising one or more gateways, wherein the one or more gateways are part of the cloud network, and wherein the one or more gateways are configured to establish a first data link between the one or more reference anchors and the cloud server.

Example 13 is an indoor positioning system network according to any example herein, in particular example 12, wherein the one or more gateways are configured to establish a second data link between the portable locator tag and the cloud server.

Example 14 is an indoor positioning system network according to any example herein, in particular example 2, wherein the server is a local server.

Example 15 is an indoor positioning system network according to any example herein, in particular example 14, wherein the local server is part of a local area data network, wherein the local area data network comprises the portable locator tag and the one or more reference anchors.

Example 16 is an indoor positioning system network according to any example herein, in particular example 7, wherein the first processor onboard the portable locator tag is configured to generate a telemetry data stream comprising inertial measurement data from which speed, movement direction, and/or orientation of the portable locator tag is estimated.

Example 17 is an indoor positioning system network according to any example herein, in particular example 10, wherein the second processor onboard the one or more reference anchors is configured to process the ranging signal received by the second transceiver to determine an operational set of ground truth positional coordinates of the portable locator tag.

Example 18 is an indoor positioning system network according to any example herein, in particular example 17, wherein the ranging signal is a first ranging signal, and wherein: the second processor onboard the one or more reference anchors is configured to execute software instructions computing an angle of arrival of the first ranging signal received by second transceiver with respect to a set of first relative positions of the one or more reference anchors; the first processor onboard the portable locator tag is configured to execute software instructions computing the angle of departure of a second ranging signal transmitted by the one or more reference anchors and received by the first transceiver with respect to a second relative position of the portable locator tag; or the second processor is configured to compute the second relative position of the portable locator tag by a multi-lateration computation based on a phase-based ranging measurement, a round trip time measurement or a time-of-flight measurement of a third ranging signal transmitted by the first transceiver or by the second transceiver.

Example 19 is a machine-readable storage medium having one or more machines with instructions stored thereon, that when executed, cause the one or more machines to perform a method for operating an indoor positioning system network, the method comprising: sending a plurality of ranging signals between individual tags of a plurality of tags and individual reference anchors of a plurality of reference anchors; computing a set of positional coordinates of the individual tags of the plurality of tags; sending ground-truth training datasets to a deep learning model by the plurality of reference anchors, wherein the ground-truth training datasets comprise the set of positional coordinates and a set of inertial data of the individual tags of the plurality of tags; correlating, by the deep learning model, the set of positional coordinates of the individual tags to the set of inertial data of the individual tags; and training the deep learning model to estimate positions of the individual tags based at least in part on inertial data.

Example 20 is a machine-readable storage medium according to any example herein, in particular example 19, wherein sending the plurality of ranging signals between the individual tags and the individual reference anchors comprises transmitting the plurality of ranging signals from the individual tags to the individual reference anchors.

Example 21 is a machine-readable storage medium according to any example herein, in particular example 19, wherein computing the set of positional coordinates of the individual tags comprises determining an angle of arrival of individual ranging signals of the plurality of ranging signals to one or more individual reference anchors of the plurality of reference anchors.

Example 22 is a machine-readable storage medium according to any example herein, in particular example 21, wherein computing the set of positional coordinates of the individual tags comprises determining a distance between the individual tags and one or more individual reference anchors.

Example 23 is a machine-readable storage medium according to any example herein, in particular example 22, wherein sending the ground-truth training datasets to the deep learning model comprises gathering the inertial data from an accelerometer, a gyroscope and a magnetometer onboard the individual tags, wherein the inertial data is usable to estimate motion-related information of the individual tags, and combining the inertial data with the set of positional coordinates of the individual tags.

Example 24 is a machine-readable storage medium according to any example herein, in particular example 21, wherein correlating, by the deep learning model, the set of positional coordinates of the individual tags to the set of inertial data of the individual tags comprises finding one or more statistical correlations between the set of positional coordinates and the set of inertial data.

Example 25 is a machine-readable storage medium according to any example herein, in particular example 24, wherein training the deep learning model to estimate positions of the individual tags by inertial data alone comprises applying the one or more statistical correlations between the set of positional coordinates and the set of inertial data.

Example 26 is a machine-readable storage medium according to any example herein, in particular example 21, wherein the method further comprises removing at least one of the individual reference anchors of the plurality of reference anchors and estimating locations of the individual tags of the plurality of tags by using the set of inertial data from the plurality of tags.

Example 27 is a machine-readable storage medium according to any example herein, in particular example 26, wherein the method further comprises verifying accuracy of the locations of the individual tags determined by the deep learning model based on the inertial data alone, wherein the at least one of the individual reference anchors is reactivated and determines the ground truth information of the plurality of tags, wherein the at least one of the individual reference anchors computes the set of positional coordinates of the individual tags, wherein the at least one of the individual reference anchors processes the ranging signals sent by the individual tags to compute the locations of the individual tags.

Besides what is described herein, various modifications can be made to the disclosed examples and implementations thereof without departing from their scope. Therefore, illustrations of examples herein should be construed as examples, and not restrictive to scope of present disclosure.

What is claimed is:

1. An indoor positioning system network, comprising:
a portable locator tag comprising a first transceiver and an inertial measurement unit (IMU), wherein the first transceiver is configurable to transmit or receive a ranging signal and to transmit a set of inertial measurement telemetry data, wherein the set of inertial measurement telemetry data is based on the inertial measurement unit (IMU); and
one or more reference anchors comprising a second transceiver configurable to receive the ranging signal from the first transceiver, wherein the ranging signal is processed by the one or more reference anchors to determine a set of positional coordinates of the portable locator tag.

2. The indoor positioning system network of claim 1 further comprising a server configurable to execute a set of software instructions of a deep learning model stored within a memory accessible by the server.

3. The indoor positioning system network of claim 2, wherein the deep learning model is configured to process a plurality of training datasets in a training phase of operation.

4. The indoor positioning system network of claim 3, wherein the plurality of training datasets comprises a training set of ground truth positional coordinates of the portable locator tag and the set of inertial measurement telemetry data generated by the IMU onboard the portable locator tag.

5. The indoor positioning system network of claim 4, wherein the deep learning model is configured to learn to correlate the set of inertial measurement telemetry data with the set of positional coordinates of the portable locator tag during the training phase of operation.

6. The indoor positioning system network of claim 5, wherein the deep learning model is configured to predict an operational set of positional coordinates, based on a set of correlations learned during the training phase of operation, of the portable locator tag based on sets of operational inertial measurement data, with reduced or no reliance on ranging signals exchanged with the one or more reference anchors, in a post-training phase of operation.

7. The indoor positioning system network of claim 1, wherein the portable locator tag comprises a first processor, wherein the first transceiver is coupled to the first processor, wherein the IMU is coupled to the first processor.

8. The indoor positioning system network of claim 7, wherein the IMU comprises any one of an accelerometer or a gyroscope coupled to the first processor.

9. The indoor positioning system network of claim 7, wherein the IMU comprises a magnetometer coupled to the first processor.

10. The indoor positioning system network of claim 7, wherein the one or more reference anchors comprise a second processor, wherein the second transceiver is coupled to the second processor.

11. The indoor positioning system network of claim 2, wherein the server is a cloud server, wherein the cloud server is part of a cloud network.

12. The indoor positioning system network of claim 11, further comprising one or more gateways, wherein the one or more gateways are part of the cloud network, and wherein the one or more gateways are configured to establish a first data link between the one or more reference anchors and the cloud server.

13. The indoor positioning system network of claim 12, wherein the one or more gateways are configured to establish a second data link between the portable locator tag and the cloud server.

14. The indoor positioning system network of claim 2, wherein the server is a local server.

15. The indoor positioning system network of claim 14, wherein the local server is part of a local area data network, wherein the local area data network comprises the portable locator tag and the one or more reference anchors.

16. The indoor positioning system network of claim 7, wherein the first processor onboard the portable locator tag is configured to generate a data stream comprising inertial measurement data from which speed, movement direction, and/or orientation of the portable locator tag is estimated.

17. The indoor positioning system network of claim 10, wherein the second processor onboard the one or more reference anchors is configured to process the ranging signal received by the second transceiver to determine an operational set of ground truth positional coordinates of the portable locator tag during a training phase of operation.

18. The indoor positioning system network of claim 17, wherein the ranging signal is a first ranging signal, and wherein:
the second processor onboard the one or more reference anchors is configured to execute software instructions computing an angle of arrival of the first ranging signal received by the second transceiver with respect to a set of first relative positions of the one or more reference anchors;
the first processor onboard the portable locator tag is configured to execute software instructions computing an angle of departure of a second ranging signal transmitted by the one or more reference anchors and received by the first transceiver with respect to a second relative position of the portable locator tag; or
the second processor is configured to compute the second relative position of the portable locator tag by a multilateration computation based on a phase-based ranging measurement, a round trip time measurement or a time-of-flight measurement of a third ranging signal transmitted by the first transceiver or by the second transceiver.

19. A machine-readable storage medium having one or more machines with instructions stored thereon, that when executed, cause the one or more machines to perform a method for operating an indoor positioning system network, the method comprising:
sending a plurality of ranging signals between individual tags of a plurality of tags and individual reference anchors of a plurality of reference anchors;
computing a set of positional coordinates of the individual tags of the plurality of tags;
sending ground-truth training datasets to a deep learning model by the plurality of reference anchors, wherein the ground-truth training datasets comprise the set of positional coordinates and a set of inertial data of the individual tags of the plurality of tags;
correlating, by the deep learning model, the set of positional coordinates of the individual tags to the set of inertial data of the individual tags; and
training the deep learning model to estimate positions of the individual tags by inertial data alone.

20. The machine-readable storage medium of claim 19, wherein sending the plurality of ranging signals between the individual tags and the individual reference anchors comprises transmitting the plurality of ranging signals from the individual tags to the individual reference anchors.

21. The machine-readable storage medium of claim 19, wherein computing the set of positional coordinates of the individual tags comprises determining an angle of arrival of individual ranging signals of the plurality of ranging signals to one or more individual reference anchors of the plurality of reference anchors.

22. The machine-readable storage medium of claim 21, wherein computing the set of positional coordinates of the individual tags comprises determining a distance between the individual tags and one or more individual reference anchors.

23. The machine-readable storage medium of claim 22, wherein sending the ground-truth training datasets to the deep learning model comprises gathering the inertial data from an accelerometer, a gyroscope and a magnetometer onboard the individual tags, wherein the inertial data comprises inertial measurement data from which motion-related information of the individual tags is estimated, and combining the inertial data with the set of positional coordinates of the individual tags.

24. The machine-readable storage medium of claim 21, wherein correlating, by the deep learning model, the set of positional coordinates of the individual tags to the set of inertial data of the individual tags comprises finding one or more statistical correlations between the set of positional coordinates and the set of inertial data.

25. The machine-readable storage medium of claim 24, wherein training the deep learning model to estimate positions of the individual tags by inertial data alone comprises applying the one or more statistical correlations between the set of positional coordinates and the set of inertial data.

26. The machine-readable storage medium of claim 21, wherein the method further comprises removing at least one of the individual reference anchors of the plurality of reference anchors and estimating locations of the individual tags of the plurality of tags by the deep learning model using the set of inertial data from the plurality of tags.

27. The machine-readable storage medium of claim 26, wherein the method further comprises verifying accuracy of the locations of the individual tags determined by the deep learning model based on the inertial data, wherein the at least one of the individual reference anchors is reactivated and determines ground truth information of the plurality of tags, wherein the at least one of the individual reference anchors computes the set of positional coordinates of the individual tags, wherein the at least one of the individual reference anchors processes the individual ranging signals sent by the individual tags to compute the locations of the individual tags.
